(19) United States
(12) Patent Application Publication
(10) Pub. No.: US 2007/0207800 A1
(43) Pub. Date: Sep. 6, 2007

(54) Diagnostics And Monitoring Services In A Mobile Network For A Mobile Device

(76) Inventors: Robert C. Daley, Nashua, NH (US); Deven P. Shah, Orange, CA (US); Karen Chan, Richmond Hill (CA); Bindu Rama Rao, Laguna Niguel, CA (US)

Correspondence Address: MCANDREWS HELD & MALLOY, LTD, 500 WEST MADISON STREET, SUITE 3400, CHICAGO, IL, 60661, US

(21) Appl. No.: 11/676,997

(22) Filed: Feb. 20, 2007

Related U.S. Application Data
(60) Provisional application No. 60/774,406, filed on Feb. 17, 2006.

(51) Int. Cl. H04Q 7/20

(52) U.S. Cl. 455/425

(57) ABSTRACT

The present invention makes it possible to obtain debug- and other diagnostic information from mobile electronic devices in a system operator network. A Log Management object provides support for logging diagnostic data. A log file is employed to collect information on various device features for which tracing or debugging is turned on in a mobile electronic device such as, for example, a mobile handset, cellular phone, a personal digital assistant, a pager and a personal computer. It is also used to selectively collect information on specific events that are monitored, device specific data being collected, and network performance data, among other items. The diagnostic agent in the mobile device is a client side application that may run on the mobile device when required, or continuously as a monitoring application, and which manages and collects tracing information wirelessly to a server using a cellular data network. A diagnostic client may also be downloaded and executed to collect diagnostic data from applications, for example. Traps may also be set and data collected from them. The Log file may be retrieved from the server side in pull or push mode.

### RELATED APPLICATIONS

The present application makes reference to, claims priority to, and claims benefit of U.S. Provisional Application Ser. No. 60/774,406 entitled “Diagnostics And Monitoring Services In A Mobile Network For A Mobile Device” (Attorney Docket No. 17521US01 101USMD134), filed Feb. 17, 2006, the complete subject matter of which is hereby incorporated herein by reference, in its entirety.

The present application also makes reference to U.S. Patent Application Ser. No. 60/664,249 entitled “Device Client Specification”, (Attorney Docket No. 16639US01 101USMD117), filed on Mar. 21, 2005, the complete subject matter of which is hereby incorporated herein by reference, in its entirety.

In addition, this application makes reference to U.S. Provisional Patent Application Ser. No. 60/249,606, entitled “System and Method for Updating and Distributing Information,” filed Nov. 17, 2000, and International Patent Application Publication No. WO 02/41147 A1, entitled “System And Method For Updating And Distributing Information”, filed Nov. 19, 2001, and having publication date Mar. 23, 2002, the complete subject matter of each of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices such as, for example, mobile phones and personal digital assistants (PDA's), often contain firmware and application software that are either provided by the manufacturers of the electronic devices, by telecommunication carriers, or by third parties. If firmware or firmware components are to be changed in such electronic devices, it is often very tricky to update the firmware or firmware components.

It is often difficult to determine what is wrong with an electronic device when a problem is encountered. Quite often, a customer care representative for a system operator does not have answers to a customer's problem and is not able to fix it. Determination of problems with a customer's mobile device is a big problem for system operators. Answering customer care calls is quite expensive. Especially so, if at the end of such a call, the customer care representative is unable to determine what is wrong with the electronic device.

Different electronic devices have different sets of resources, different sets of parameters, etc. Managing mobile devices in a heterogeneous communication network is a huge problem: Figuring out what parameters need to be set is also a problem.

Debugging software problems that occur in mobile devices, “in the field”, is a challenging endeavor. A user or a software developer cannot step through code using a debugger. He/she must rely on debug information recorded in the memory of the mobile device during field use of the device, in order to diagnose problems with any software in the device. This information may consist of trace information, logs of data taken from a radio subsystem, stack dumps, error flags, or anything the developer has stored in specific memory reserved for debugging purposes. Currently, after trace data is recorded, the information is manually transferred from memory of the mobile device into a personal computer (PC) via a wired interface such as a universal serial bus (USB) cable, and the developer examines the debug data file on the PC. This process suffers from a number of drawbacks, however. First, the user or software developer and the problematic device may not be co-located, so obtaining the debug file is nontrivial. Second, the users of the device (typically field or beta testers) may be inconsistent about retrieving debug files from the memory of the mobile device in a timely manner and debug information may be overwritten after a period of time, so the user or software developer may never receive the needed debug information. Existing diagnostic clients work on proprietary protocols, and often on a cable/wire-based solution. These approaches are not adequate for diagnosing widely reported problems with millions of deployed mobile devices.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A device, method and system supporting control of diagnosis and tracing in a plurality of mobile electronic devices, substantially as shown in and/or described in connection with at least one of the figures, as set forth more completely in the claims.

These and other advantages and novel features of the present invention, as well as details of an illustrated embodiment thereof will be more fully understood from the following description and drawings.

### BRIEF DESCRIPTION OF SEVERAL VIEWS OF THE DRAWINGS

FIG. 1 is a perspective block diagram of an exemplary mobile network that is capable of conducting remote diagnostics on an electronic device such as, for example, a cellular phone, a personal digital assistant, a pager, a personal computer, or any of a number of other portable or handheld electronic devices, in accordance with a representative embodiment of the present invention.

FIG. 2 is a perspective block diagram illustrating an exemplary section of a DM tree that may be employed by a DM client such as the DM client or diagnostic client such as the diagnostic client of FIG. 1, to provide support for diagnostics and monitoring services, in accordance with a representative embodiment of the present invention.

FIG. 3 illustrates the logical structure of an exemplary device management sub-tree showing a Log (File) management object that supports the reporting of diagnostic data, in accordance with a representative embodiment of the present invention.

FIG. 4 shows a block diagram illustrating an exemplary diagnostic/trace client that may correspond to the functionality of the diagnostic client and/or diagnostic agent of FIG. 1, for example, in accordance with a representative embodiment of the present invention.

FIG. 5 is a block diagram illustrating the relationships between Users, User Groups, electronic devices, Subscribers, and Subscriber Classes, in accordance with a representative embodiment of the present invention.

FIG. 6 illustrates an exemplary web page user interface screen for searching a database of Users, in accordance with a representative embodiment of the present invention.

FIG. 7 illustrates an exemplary web page user interface screen for editing entries in a database of Users, in accordance with a representative embodiment of the present invention.

FIG. 8 illustrates an exemplary web page user interface screen for searching a database of Subscribers, in accordance with a representative embodiment of the present invention.

FIG. 9 illustrates an exemplary web page user interface screen for editing entries in a database of Subscribers, in accordance with a representative embodiment of the present invention.

FIG. 10 illustrates an exemplary web page user interface screen for importing Subscriber information into a database of Subscribers, in accordance with a representative embodiment of the present invention.

FIG. 11 illustrates an exemplary web page user interface screen for searching a database of Devices that may correspond to, for example, electronic device such as the electronic device of FIG. 1, in accordance with a representative embodiment of the present invention.

FIG. 12 illustrates an exemplary web page user interface screen for editing entries in a database of Devices that may correspond to, for example, electronic device such as the electronic device of FIG. 1, in accordance with a representative embodiment of the present invention.

FIG. 13 illustrates an exemplary web page user interface screen for importing Device information into a database of Devices that may correspond to, for example, electronic device such as the electronic device of FIG. 1, in accordance with a representative embodiment of the present invention.

FIG. 14 shows an illustration of an exemplary SC_TRACE_DATA table and its relationship to other system tables, in accordance with a representative embodiment of the present invention.

FIG. 15 illustrates an exemplary web page user interface screen for displaying diagnostic/trace data from, for example, an electronic device such as the electronic device of FIG. 1, in accordance with a representative embodiment of the present invention.

FIG. 16 illustrates an exemplary web page user interface screen for displaying detailed information from trace data that may correspond to the diagnostic/trace data of FIG. 15, in accordance with a representative embodiment of the present invention.

FIG. 17 illustrates an exemplary web page user interface screen for displaying trace statistics from trace data that may correspond to the diagnostic/trace data of FIG. 15, in accordance with a representative embodiment of the present invention.

FIG. 18 illustrates an exemplary web page user interface screen for displaying device information that may correspond to an electronic device such as the electronic device of FIG. 1, in accordance with a representative embodiment of the present invention.

### DETAILED DESCRIPTION OF THE INVENTION

Aspects of the present invention relate generally to the management of mobile devices. More specifically, aspects of the present invention relate to the use of managed objects for diagnostics and monitoring of mobile/handheld electronic devices such as, for example, a mobile handset, a cellular phone, a personal digital assistant, a pager, a personal computer, or any of a number of other portable or handheld electronic devices with communication functionality. Although much of the following discussion relates to a mobile handset or mobile device such as a cellular phone, the teachings of the present invention also apply to any of a wide variety of electronic devices with wired or wireless communication functionality that provide subscriber access to communication services such as, for example, those named above, and other electronic devices having similar characteristics.

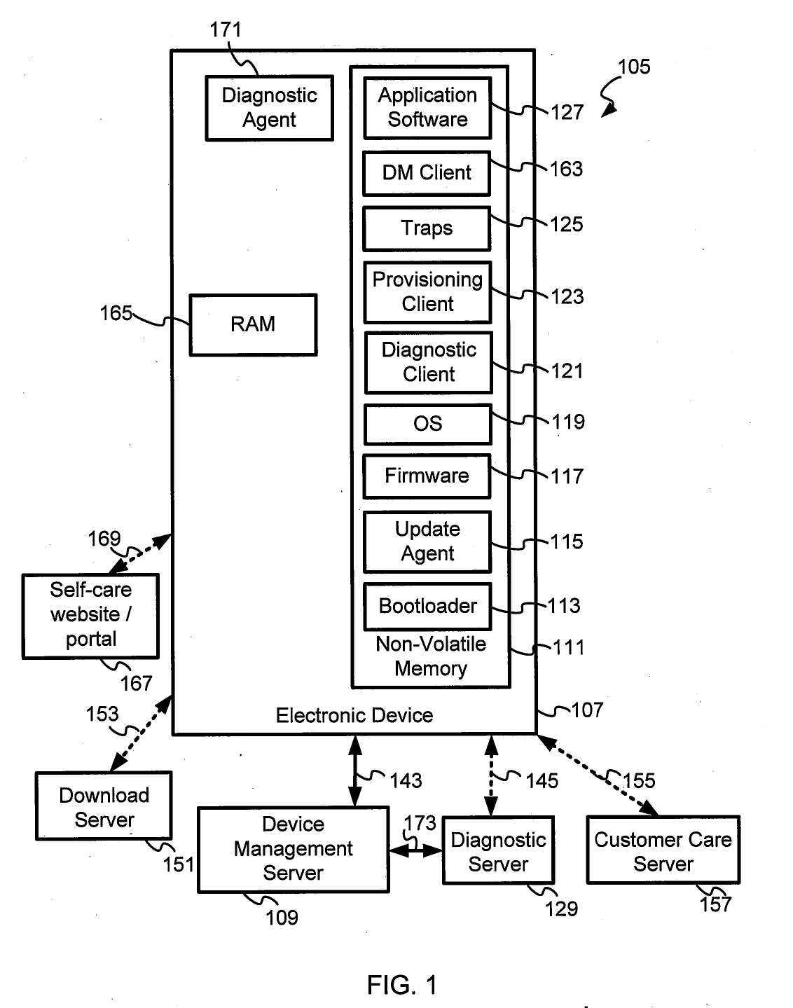

FIG. 1 is a perspective block diagram of an exemplary mobile network 105 that is capable of conducting remote diagnostics on an electronic device 107 such as, for example, a cellular phone, a personal digital assistant, a pager, a personal computer, or any of a number of other portable or handheld electronic devices, in accordance with a representative embodiment of the present invention. In a representative embodiment of the present invention, the electronic device 107 may support diagnostics features wherein applications may be downloaded and installed on the electronic device 107, to monitor applications and diagnose problems if needed.

A mobile network in accordance with the present invention such as, for example, the mobile network 105 shown in the illustration of FIG. 1, may comprise the electronic device 107, the customer care server 157, a device management (DM) server 109, a download server 151, a diagnostic server 129, and a self-care website/portal 167. Although these network elements are shown in the example of FIG. 1 as individual entities, this is for reasons of illustration and clarity, and does not represent a specific limitation of the present invention. Any or all of these network server elements may be co-resident, in any combination, on one or more servers without departing from the spirit and scope of the present invention.

As shown in FIG. 1, the electronic device 107 is communicatively linked to the customer care server 157, the device management (DM) server 109, the download server 151, the diagnostic server 129, and the self-care website/portal 167 via respective communication links 155, 143, 153, 145, and 169. The communication links 155, 143, 153, 145, and 169 may comprise any of a number of types of wired or wireless links such as, for example, a wireless cellular network, a wireless paging network, and wired networks such a public switched telephone network, a packet network, a private network, and the Internet. Although not shown in FIG. 1, one of skill in the art will recognize upon reading this disclosure that the individual communication links 155, 143, 153, 145, and 169 may, in fact, comprise a single wireless path supporting communication with the electronic device 107.

In a representative embodiment of the present invention, the electronic device 107 may, for example, comprise a non-volatile memory 111, and a random access memory (read/write memory) RAM 165. The non-volatile memory 111 may, for example, comprise flash-type memory, and may contain application software 127, a DM client 163, a traps client 125, a provisioning client 123, a diagnostic client 121, a diagnostic agent 171, an operating system (OS) 119, firmware 117, update agent(s) 115, and a boot loader 113. In a representative embodiment of the present invention, a DM client such as the DM client 163 may received DM commands from a DM server such as the DM server 109, and may interact with a provisioning client such as the provisioning client 123 to implement the received DM commands. The DM commands may be, for example, those in accordance with an Open Mobile Alliance (OMA) Device Management (DM) Version 1.2 or later protocol, as developed under the sponsorship of the Open Mobile Alliance, Ltd.

A representative embodiment of the present invention may comprise a traps client such as the traps client 125, which may facilitate setting traps and retrieving collected information. Diagnostics firmware such as, for example, the diagnostic client 121 may act to facilitate remote diagnosis of the electronic device 107. Update agent firmware such as the update agent(s) 115 may enable the updating of firmware, software and configuration information in the electronic device 107, and may be employed to update, for example, application software 127, operating system (OS) 119, or firmware 117 in the electronic device 107. The update agent(s) 115 may employ an update package delivered by, for example, the download server 151, which is used to download firmware and software updates to mobile devices in the mobile network 105. The electronic device 107 in a representative embodiment of the present invention is capable of applying the received updates using one or more update agents 115 that are each capable of processing update packages or subsets thereof.

A mobile device in accordance with the present invention may also receive provisioning information from, for example, a customer care server such as the customer care server 157, or a provisioning server (not shown). A provisioning client such as, for example, the provisioning client 123 may process the received provisioning information to correct configuration problems or to reconfigure software and hardware of the electronic device 107. Device capability information stored in non-volatile memory 111 of the electronic device 107 may be modified as necessary when this occurs.

The electronic device 107, which may comprise a mobile device such as those described above, may be used by a customer to request customer care service via a customer care server 157. Device capability information retrieved from the electronic device 107 may be a part of the parameters provided to the customer care server 157. A customer service representative (CSR) may provide a service to the customer using the electronic device 107, after determining the device capability information retrieved from the electronic device 107. In this manner, a representative embodiment of the present invention may make it unnecessary for a customer to provide such information him/herself to a CSR. The mobile network 105 may support remote diagnostics by a CSR via a customer care server such as the customer care server 157. An electronic device (e.g., the electronic device 107) of the mobile network 105 of FIG. 1 may support a diagnostic data collection request from a diagnostic server 129, and may return collected diagnostics data to the diagnostics server 129, or to another authorized server in the mobile network 105. For example, the customer/subscriber using the electronic device 107 may be having problems and need help in diagnosing the problems. A mobile network in accordance with the present invention (e.g., the mobile network 105 of FIG. 1) facilitates diagnosis of problem by a CSR via the customer care server 157, as well as by the diagnostic server 129.

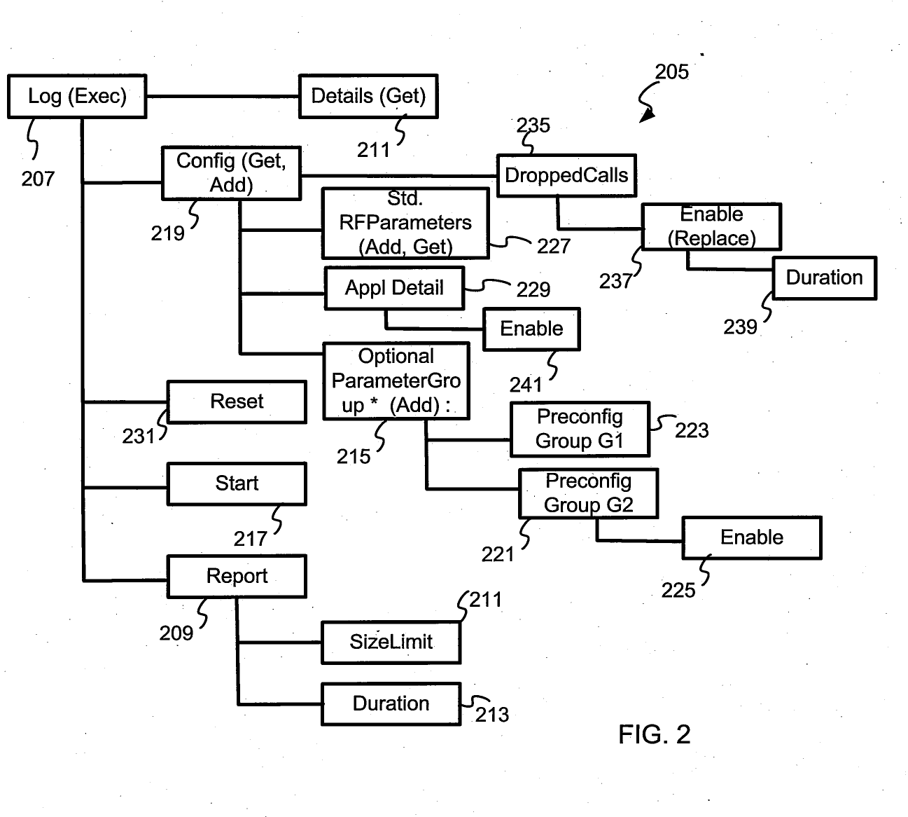

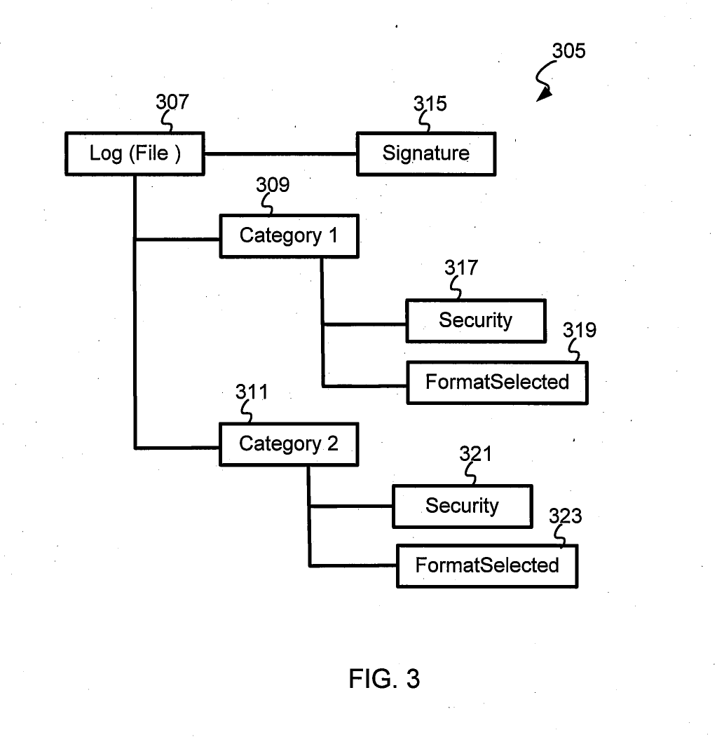

A representative embodiment of the present invention makes it possible to obtain debugging and other diagnostic information from mobile devices (e.g., electronic device 107) in an operator network such as a cellular or paging network, for example. An exemplary Log management object (MO) is illustrated in FIG. 2 that supports collecting and logging diagnostic data from electronic devices such as those previously described. In a representative embodiment of the present invention, a log file such as, for example, the log file illustrated in FIG. 3, may be employed to collect information on various device features for which diagnosis data collection or tracing/debugging is turned on in an electronic device such as the electronic device 107 of FIG. 1. The log file in FIG. 3 may also be used to selectively collect information on specific events that are monitored, device specific data being collected, and network performance data, for example. In a representative embodiment of the present invention, the diagnostic agent 171 of FIG. 1 in an electronic device such as the electronic device 107 may comprise a client side application that runs on the electronic device 107 as required. A diagnostic client in accordance with a representative embodiment of the present invention may always be present and running in an electronic device, as a monitoring application. A diagnostic client such as the diagnostic client 121 of FIG. 1, for example, may manage diagnostic/trace data collection and deliver collected tracing information wirelessly to a server such as, for example, the diagnostic server 129, using cellular data networks, for example. A diagnostic client such as the diagnostic client 121 of FIG. 1 may also be downloaded when needed and executed to collect diagnostic data from applications in the electronic device 107, for example. In addition, Traps client 125 may set traps in the firmware and software of the electronic device 107, and data may be collected from the electronic device 107 about the set traps. In a representative embodiment of the present invention, a Log file may be received by a server such as, for example, the diagnostic server 129 of FIG. 1, from an electronic device like electronic device 107, using either pull or push mode exchange.

In a representative embodiment of the present invention, a log file may be employed to collect information on various device features for which tracing or debugging is enabled (i.e., turned on). Such a log file may also be used to selectively collect information on specific events that are monitored, device specific data being collected, and network performance data, for example. Representative embodiments of the present invention make it possible to obtain debug and other diagnostic information from mobile devices such as the electronic device 107 of FIG. 1, in the field (i.e., away from traditional service facilities or locations). In one representative embodiment of the present invention, the diagnostic agent 171 in an electronic device such as, for example, the electronic device 107 of FIG. 1, comprises a client side application that runs on an electronic device when required. In another representative embodiment of the present invention, the diagnostic agent 171 may run on an ongoing basis, as a monitoring application. Diagnostic and trace information collected by the diagnostic agent 171 may be sent to a remote server using, for example, a wireless network such as a cellular data or paging network, or any other wired or wireless network having the ability to transport such data from the electronic device to a server such as the diagnostic server 129 or customer care server 157 of the mobile network 105 of FIG. 1, for example. In a representative embodiment of the present invention, the diagnostic agent may comprise embedded software capable of collecting data upon request, and capable of saving the collected data in a log file or other storage structure. In a representative embodiment of the present invention, the diagnostic server 129 may comprise a server-side application which receives, processes, and stores/presents information obtained from an electronic device such as the electronic device 107, for example, in an easily readable/understandable form. In various representative embodiments of the present invention, a personal computer (PC) may be used to accept the collected diagnostic/trace information from an electronic device such as the electronic device 107, via a universal serial bus (USB) connection, a short range wireless protocol such as that referred to by the trademarked name of Bluetooth, or via a portable memory device such as those referred to as Secure Digital (SD) cards. These means of retrieval may be employed when wireless data service for over-the-air (OTA) transfer is unavailable.

In a representative embodiment of the present invention, a diagnostic client such as the diagnostic client 121 of FIG. 1 may comprise downloadable diagnostic client firmware/software that executes specific diagnostic tasks such as, for example, monitoring of a task/application and collecting diagnostic data for the task/application, collecting configuration data related to network connectivity, application configuration, user preferences, or collecting network performance data. In a representative embodiment of the present invention, a traps client such as the traps client 125 may facilitate the setting of traps in the firmware or software of the electronic device. Each trap may be associated with a collection method and an optional reporting method. Traps may be triggered by the occurrence of specific events, or upon certain conditions or meeting specific criteria, and may be used to collect data related to errors, faults encountered while operating the electronic device 107, network performance data, and call setup data, for example. In a representative embodiment of the present invention, the traps client 125 and the diagnostic agent 171 may be combined into one embedded diagnostic client component capable of supporting traps as well as collecting diagnostic data and configuration information, for example, for eventual transfer to a diagnostic server or customer care server such as the diagnostic server 129 or the customer care server 157 of FIG. 1, for example.

Representative embodiments of the present invention employ a device management (DM) approach for mobile diagnostics, wherein management objects (MOs) are created and used for diagnosing each feature domain or application. Each of the diagnostics-related management objects may comprise parameters to be monitored, configuration data to be set, and tracing information to be collected, to name only a few examples contemplated. Each application installed in an electronic device such as the electronic device 107 of FIG. 1 may provide associated diagnostics management objects that are stored as part of configuration or management related MOs (e.g., sub-nodes of an associated application management object) for that application. Alternatively, such diagnostics management objects may be stored as sub-nodes of the standards-defined management objects such as the “DevDetail” management object described in the Open Mobile Alliance (OMA) Device Management (DM) Version 1.2 protocol standard, developed under the guidance of the Open Mobile Alliance, Ltd. Such management objects may be part of a device management (DM) tree in memory in the electronic device 107, for example.

System operators/service providers associated with the mobile network 105 may enable/disable device tracing of applications in an electronic device such as the electronic device 107, as the need arises. For example, even if an electronic device such as the electronic device 107 supports debugging of application settings and application resource usage, the operator of the wireless network providing service(s) may disable (e.g., either temporarily or permanently) some of the tracing features, or configure them as enabled when they are needed.

In various representative embodiments of the present invention, the collected trace information may be retrieved from the electronic device as a log file, or as trap information sent by a trap set on specific electronic devices. When a log file is employed, the collected information may be retrieved as, for example, an extensible markup language (XML) file, a binary file uploaded from the electronic device, as a structured file (e.g., formatted per a well defined format and structure based on standards or proprietary as defined by the manufacturer of the electronic device or the diagnostic client 121 or diagnostic agent 171), or as device-specific formatted content.

FIG. 2 is a perspective block diagram illustrating an exemplary section of a DM tree 205 that may be employed by a DM client such as the DM client 163 or diagnostic client such as the diagnostic client 121 of FIG. 1, to provide support for diagnostics and monitoring services, in accordance with a representative embodiment of the present invention. As shown in the illustration of FIG. 2, a Log management object 205 comprises a Details (Get) management object 211, a Config (Get, Add) management object 219, a Reset management object 231, a Start management object 217, and a Report management object 209. The Details (Get) management object 211, Reset management object 231, and Start management object 217 have no sub-nodes and contain no lower level management objects.

In the example illustrated in FIG. 2, the Config (Get Add) management object 219 has a DroppedCalls management object 235, a Std. RFParameters (Add, Get) management object 227, an Appl Detail management object 229, and an Optional Parameter Group* (Add) management object 215. The Report management object 209 has a SizeLimit management object 211, and a Duration management object 213. The Log MO makes it possible to collect diagnostic information and store it or manipulate it as part of the DM Tree that is managed by the DM client in the electronic device 107. The Std. RFParameters (Add, Get) management object 227 has no sub-nodes. The DroppedCalls management object 235, however, has an Enable (Replace) management object 237, which has a Duration management object 239. The Appl Detail management object 229 has an Enable management object 241, and the Option Parameter Group* (Add) management object 215 has a Preconfig Group G1 management object 223, and a Preconfig Group G2 management object 221, which has an Enable management object 225.

A method in accordance with a representative embodiment of the present invention may support the following:
Logging of diagnostic data and retrieving it in pull or push mode;
Configuring of the diagnostic data collection;
Configuring and collecting data related to radio frequency (RF) parameters, applications, network parameters, connectivity parameters, and resources used by applications, for example;
Preconfigured sets of traps that can be activated, enabled or disabled, for example;
Support for a “Get” command on, for example, a “Log” management object, to retrieve diagnostics data via a DM server;
Support for an “Exec” command on, for example, a “Log” management object, in order to start the logging process based on a configured set of diagnostic choices and parameters;
Support for a “Reset” of the collected Log file, wherein Reset can delete or reset all collected data that might be necessary;
Reporting based on size limits and/or duration of collection of diagnostics data; and
Support for enabling and disabling of diagnostics tasks.

In a representative embodiment of the present invention, all parameters settable on an electronic device (e.g., the electronic device 107 of FIG. 1) by a user or by a DM server may be monitored, retrieved and/or saved in the associated log file, through the use of the Log management object. For example, in one representative embodiment of the present invention, a brief default set of data may be logged periodically in the device when enabled. This may include, for example, an electronic device ID, basic information about the electronic device, and tracing information on, for example, battery level, dropped calls, and connectivity parameters. All of this information may be provided in the log file in XML format. In another representative embodiment of the present invention, other parameters such as, for example, radio diagnostic data and data services provided to a subscriber over Internet protocol (IP) may be collected in the log file. In a representative embodiment of the present invention, a diagnostic agent such as the diagnostic agent 171 of FIG. 1, for example, may be employed for tracing calls and crash handling capabilities.

In some representative embodiments of the present invention, uploading of the log file results in the automatic deletion of the log file in the electronic device 107. In other representative embodiments, the log file is not deleted, even after it has been transferred to a server such as, for example, the device management server 109, diagnostic server 129 or the customer care server 157 of FIG. 1, until after the server side (e.g., via the DM server 109) requests such a delete. This may be accomplished, for example, by invoking a “Reset” node being on a management object associated with the log file (e.g., using a “Reset” parameter on a Log management object such as, for example, the Reset management object 231 of Log management object 207, in the example of FIG. 2).

There are a number of ways in accordance with a representative embodiment of the present invention that diagnostics data may be generated on an electronic device such as the electronic device 107 of FIG. 1. For example, a diagnostics agent such as the diagnostic agent 171 of FIG. 1, and/or a diagnostics client such as the diagnostic client 121 of FIG. 1 may employ application program interfaces (APIs) provided in the firmware and/or software of the electronic device 107, to receive debugging data, and/or device specific information, for example. The diagnostic agent 171 and diagnostic client 121 may also employ other APIs to store and/or manage the data on the electronic device 107, may transmit the data to an off-device storage area such as an SD card or subscriber identification module (SIM) card, and may transfer trace data by OTA means to a diagnostic server such as, for example, the diagnostic server 129 of FIG. 1. In a representative embodiment of the present invention, such OTA means may be either proprietary or standards-based (e.g., may comply with the OMA-DM protocol specification or use hypertext transport protocol (http)).

In a representative embodiment of the present invention, debug messages or trace messages included in the software and/or firmware of an electronic device like the electronic device 107 of FIG. 1, for example, such as during software development, may be collected on the electronic device 107 by enabling tracing. Tracing may be enabled, for example, either remotely via a DM server such as the DM server 109 of FIG. 1, or locally by a user of the electronic device 107. When tracing is invoked, software/firmware modules (e.g., functions, subroutines, library code) may write specific data into memory or into the log file. In some representative embodiments of the present invention, the trace messages may be assembled in memory (e.g., RAM) of the electronic device 107 before being written into the log file in FLASH-type memory. Binary data as well as text data may thus be stored in the log file. Error codes encountered may also be logged. Thus, in accordance with a representative embodiment of the present invention, tracing may be turned off or turned on (i.e., disabled or enabled) using a management object to control tracing. A representative embodiment of the present invention may also support the concept of trace levels. Tracing may be automatically enabled by a diagnostic agent such as, for example, the diagnostic agent 171 of the electronic device 107, or by other agents in the electronic device 107, when software and/or firmware is known to crash (malfunction) in the electronic device 107. Such anticipatory tracing makes it possible for a representative embodiment of the present invention to collect data for a problem that is expected to occur at some time in the future, based upon previous encounters. In accordance with a representative embodiment of the present invention, tracing data transferred by the electronic device 107 to the diagnostic server 129 may be processed and provided as viewable data by the diagnostic server 129, for analysis by a human engineer for subsequent corrective steps.

FIG. 3 illustrates the logical structure of an exemplary device management sub-tree 305 showing a Log (File) management object 307 that supports the reporting of diagnostic data, in accordance with a representative embodiment of the present invention. The log file associated with the Log (File) management object 307 may, for example, be created, managed and used to store diagnostics-related information, by the Log management object 207 described above with reference to FIG. 2. In a representative embodiment of the present invention, a Log management object such as, for example, the Log management object 207 of FIG. 2 may be managed by means of the DM client 163 in the electronic device 107.

In a representative embodiment of the present invention, diagnosis of several different user agents or applications may be supported by an electronic device such as the electronic device 107 of FIG. 1. For example, user agents for firmware update over-the-air (FOTA), push-to-talk over cellular (PoC), instant messaging (IM), and web browsing, for example, may be employed in an electronic device such as the electronic device 107. Any of these user agents may encounter problems during operation. In a representative embodiment of the present invention, each of these user agents may be associated with its own management object (or sub-nodes) of a device management tree, and the diagnosis of the parameters set in these management objects may be supported by a diagnostics agent such as the diagnostic agent 171 of FIG. 1. Any associated data collected may be stored in the Log file MO 307, in a structured format. This structured format may provide for categorization and storage of diagnostic data, with and without security. Some categories of data may involve encryption for security, while others may involve encoding for transport flexibility. In addition, diagnostic clients that are downloaded and installed, such as those downloaded and installed when new applications are installed or an existing application is updated, may also store their data in the same Log file MO 307.

In one embodiment, the Log file MO 307 may enable collection of categories of diagnostic data that are each associated with a security mechanism and a format for layout. The security mechanism and the format information may also be provided in the Log file MO 307 such that a consumer of the Log file MO 307 may use them to retrieve and process the diagnostic data.

The Log file MO 307 may be digitally signed for security, and a signature 315 may be included in the Log file MO 307. The Log file MO 307 may be transferred to a diagnostic server over a ftp (file transfer protocol) connection, an htpp (hypertext transfer protocol) connection, a short range wireless network connection such as that referred to by the name Bluetooth, or any of a variety of other communication paths. In one representative embodiment of the present invention, the Log file MO 307 may be communicated by a DM client 163 in the electronic device 107 over an http connection by means of an http “POST” mechanism. In another representative embodiment of the present invention, the Log file MO 307 may be communicated by the DM client 163 in the electronic device 107 by means of an ftp mechanism. In yet another embodiment, it is communicated over the large object download mechanism of the OMA DM protocol supported by the DM client 163.

A representative embodiment of the present invention may support settable device tracing parameters on an electronic device such as the electronic device 107 of FIG. 1 including, for example, variable buffer sizing, debug levels, components to debug, data transmission method (e.g., TCP/IP, SD card, USB), data transmission trigger, and a “Clear Buffer” command.

In a representative embodiment of the present invention, a user interface for a server such as, for example, the customer care server 157 of FIG. 1 may display electronic device identification (ID) information, basic information about an electronic device, and trace data file contents in XML format. Some or all of collected trace data may be transferred over-the-air to a server such as the device management server 109, diagnostic server 129 and/or customer care server 157. Trace data may also be dumped to an SD card via an SDIO slot on the electronic device, and/or to a PC via a USB connection on the electronic device.

In a representative embodiment of the present invention, a client-side application such as the diagnostic agent 171 or diagnostic client 121 of the electronic device 107 of FIG. 1, for example, may support tracing calls, component and trace-level filtering, crash handling, tracing in interrupt routines and multiple threads. Such client-side functionality may include data triggering capabilities including, for example, triggers based on trace level, firmware, software and/or hardware component, immediate dump requests, periodic triggers, and/or triggers based on a buffer fullness condition, to name only a few possible examples.

In a representative embodiment of the present invention, does not interfere with normal operation of the electronic device being monitored or diagnosed, even under heavy loading conditions. In a representative embodiment of the present invention, the client-side firmware and/or software may support a client-side call into a trace functions every 10 ms, and each call may transfer a 1 kilobyte of data.

Table 1, below, lists the acronyms and abbreviations used in this document:

TABLE 1

| | |
|---|---|
| API | Application programming interface |
| CSV | Command Separated Values |
| Device ID | Refers to the IMEI (International Mobile Equipment |
| | Identity), the device ID within a GSM network. |
| EDGE | Enhanced Data rates for Global Evolution (EDGE) - a |
| | radio based high-speed mobile data standard. The EDGE |
| | standard allows for data transmission speeds of 384 |
| | kbps to be achieved when all eight timeslots are used. |
| ESN | Electronic Serial Number |
| GSM | Global System for Mobile Phones |
| GPRS | General Packet Radio Service |
| HTTP | Hypertext Transfer Protocol |
| IMEI | International Mobile Equipment Identity |
| J2EE | Java Version 2.0, Enterprise Edition |
| JMS | Java Message Service |
| MIN | Mobile Identification Number |
| MSISDN | “Mobile Station Integrated Services Digital Network”, |
| | commonly used as “mobile phone number on a GSM |
| | network”. |
| SMS | Short Message Service - a simple store and forward |
| | text messaging system. |
| USB | Universal Serial Bus - an external bus standard that |
| | supports data transfer rates of 12 Mbps. A single USB |
| | port can be used to connect up to 127 peripheral |
| | devices, such as mice, modems, and keyboards. |
| UTC | Coordinated Universal Time - a time scale that couples |
| | Greenwich Mean Time, which is based solely on the |
| | Earth's inconsistent rotation rate, with highly |
| | accurate atomic time. When atomic time and Earth |
| | time approach a one second difference, a leap second |
| | is calculated into UTC. UTC was devised on Jan. 1, |
| | 1972 and is coordinated in Paris by the International |
| | Bureau of Weights and Measures. UTC, like Greenwich |
| | Mean Time, is set at 0 degrees longitude on the prime |
| | meridian. |

Table 2, below, lists exemplary terminology and definitions used in this document:

| | |
|---|---|
| Device | Represents a single device identified on the mobile |
| Instance | network by its “Device ID” (IMEI or ESN). Under |
| | normal circumstances, each device instance may be |
| | associated with a specific subscriber MSISDN or MIN, |
| | except for “borrowed” or “stolen” devices |
| | discovered on a GSM mobile network. |
| User | A person who is allowed to login to a system to review |
| | trace/diagnostic information and to perform administra- |
| | tive tasks. |
| User Group | An entity used for grouping users with common attributes. |
| Subscriber | A mobile phone account owner in a carrier's network, |
| | known to the system by the mobile phone number. |
| Subscriber | Defines a set of subscriber attributes, common to a set |
| Class | of subscribers. A Subscriber class may be used to define |
| | provisioning attributes associated with geographic |
| | region and a class of subscriber service (e.g., consumer, |
| | corporate, pre-paid, basic, premier, elite, etc.). |

In a representative embodiment of the present invention, a diagnostic server such as the diagnostic server 129, may be incorporated into servers of an existing device management platform, or may be implemented as one or more servers dedicated to the monitoring and diagnostic functions described herein.

In a representative embodiment of the present invention, a trace client such as the diagnostic client 121 and diagnostic agent 171 may support device initiated logging and uploading of logged information to a trace server such as the diagnostic server 129, as well as to a USB attached PC, and/or a removable handset SD card. The following discussion illustrates some of the functionality of a trace client in accordance with the present invention such as, for example, the diagnostic client 121 and diagnostic agent 171.

A representative embodiment of the present invention may provide a native shared library service that may be called from other applications, other shared libraries, and also during interrupt time, to record errors, warnings, and other events of interest in an electronic device.

In a representative embodiment of the present invention, each log entry may be recorded with a component ID, a sub-component ID, and a severity level of an event. The ability to include optional binary data (e.g., a stack trace) and/or a text message may be provided.

In a representative embodiment of the present invention, message logging may be controlled by a filter that specifies one or more component and sub-component pairs, and associated severity levels of the messages to be logged. If the component and sub-component IDs are not matched within the filter, or if the severity level of a matched filter entry is lower (e.g., less severe) than the message to be logged, the message may be discarded and the logging process may return to its caller.

In a representative embodiment of the present invention, caller thread operations may be written to a dedicated RAM buffer by native processor code such as, for example, code for an ARM processor from ARM, Ltd. Movement of log messages to other, slower storage targets may be performed by lower priority threads.

In a representative embodiment of the present invention, the main RAM log buffer may be implemented as a “circular buffer”, in which the oldest log messages may be discarded if processes for moving data to other storage targets fall behind.

In a representative embodiment of the present invention, an option to configure a larger internal flash “backup” buffer may be provided. This internal flash buffer may be supported by a background thread that regularly moves log data from RAM to internal flash to free RAM log space. Such a thread may run at a priority lower than the priority of any caller of the logging service, but higher than the thread that moves log data from internal device memory to an external target.

In a representative embodiment of the present invention, information moved to internal flash may be maintained as a set of flash files. Flash file size may be limited to 64 KB in length for flash performance reasons. Log messages may not be split across flash files. If the amount of internal flash memory may be exceeded, the oldest flash file may be overwritten to ensure that the newest log information is preserved.

In a representative embodiment of the present invention, a “real time” logging mode may be provided in which log messages are written directly to a USB attached PC. When real time mode is active, log information may not be logged to internal memory, except possibly for buffering purposes. Once the log message is successfully received by the PC, it may no longer be retained in internal memory in an electronic device such as, for example, the electronic device 107, for example.

In a representative embodiment of the present invention, the use of a “special” key sequence may invoke a dialog box/screen for setting log mode, “trigger” criteria, buffer sizes, external upload target(s), and filter criteria, for example. The user interface for this dialog box/screen may be modeled after other log configuration dialog boxes/screens with appropriate additions and changes. A representative embodiment of the present invention may permit entry of component and sub-component IDs that were not known at the time the operating system of an electronic device was built, when the descriptive name may not be known.

In a representative embodiment of the present invention, a trace server such as, for example, client-side software/firmware such as the diagnostic client 121 and/or diagnostic agent 171 of an electronic device may receive and process a complete set of configuration information from a trace server such as the diagnostic server 129, to configure remotely any parameters that are configurable locally on the electronic device.

In a representative embodiment of the present invention, a logging service may expose a shared library interface for changing and reconfiguring log filters, settings, and trigger criteria, for example. This logging service may be used both by a device logging configuration dialog while handling server configuration request messages, and also by local device-side diagnostics or testing software.

In a representative embodiment of the present invention, the following “triggers” may be supported for initiating log data uploading to one or more configured external targets, described above:
Specific requests from a diagnostic server over SMS.
Log data reaching a pre-specified log message threshold.
A message matching specific filter criteria (e.g., a specifically flagged component, subcomponent, and severity level).
Periodic triggers, based on a configured time interval.

In a representative embodiment of the present invention, a logging service may expose an interface for retrieval of log messages from an internal log buffer of an electronic device. This interface may be used, for example, for device-side acceptance testing, to check that the messages that should be in the log are there, with no “unwanted” information.

In a representative embodiment of the present invention, a diagnostic client such as the diagnostic client 121 and/or diagnostic agent 171 may provide the ability to remotely configure OTA connectivity settings over SMS, using methods of a customer care system such as, for example, the SmartCare or FusionDM system available from Bitfone Corporation.

In a representative embodiment of the present invention, a logging “transfer” service may provide a means of moving internal log data (e.g., stored RAM or flash) to one or more of the following external targets, in the following priority order:
1. a trace server such as the diagnostic server 129 of FIG. 1, for example,
2. a USB attached PC,
3. a removable device SD card.

When multiple targets are configured, “blocks” of log data may be written to each target in priority order. If all three external targets are configured, “blocks” of log data may, for example, be written in the following order:
1. log data block 1 to the trace server,
2. log data block 1 to PC,
3. log data block 1 to SD card,
4. log data block 2 to the trace server
5. log data block 2 to PC
6. etc.

In a representative embodiment of the present invention, successful transfer of a block of log data to any external target may release (e.g., erase) the internal storage for that log data.

In a representative embodiment of the present invention, transfer of log data to an external target (e.g., a diagnostic/trace server, a USB interface to a PC, or an SD card) may run at a lower priority than a thread that moves data from RAM to internal flash (e.g., when internal flash is configured). This helps to assure that storage for RAM log data continues to be available for new log messages.

In a representative embodiment of the present invention, each log message transfer may have a header that includes information such as, for example:
message version, format, and type,
transfer block message length,
unique “boot” number
time information in device precision and locality,
device ID (e.g., ESN, IMEI, etc.),
subscriber phone number when available.

In a representative embodiment of the present invention, a logging service (e.g., in the diagnostic agent 171 and/or diagnostic client 121) may provide a means of clearing all internal log buffers, either from a configuration dialog of an electronic device like the electronic device 107, or via an SMS request by a trace/diagnostic server such as the diagnostic server 129, for example.

In a representative embodiment of the present invention, a trace/diagnostic server functionality may comprise a new service built upon an existing customer care system such as the SmartCare/FusionDM server architecture of Bitfone Corporation, or a separate standalone server architecture, to support the management of, and data collection from, diagnostic/trace-enabled devices. The following diagnostic/trace server functionally may be provided in a representative embodiment of the present invention:

In a representative embodiment of the present invention, a diagnostic/trace server such as the diagnostic server 129 may be able to trigger a log data transfer on an electronic device such as the electronic device 107 of FIG. 1, by sending an SMS notification to the electronic device.

In a representative embodiment of the present invention, a diagnostic/trace server such as the diagnostic server 129 may be able to clear all log data on the electronic device (e.g., electronic device 107) by sending an SMS notification to the device.

In a representative embodiment of the present invention, a diagnostic/trace server such as the diagnostic server 129 may be able to collect available trace settings and log filter settings from the electronic device using OTA methods.

In a representative embodiment of the present invention, a diagnostic/trace server such as the diagnostic server 129 may be able to configure available trace settings and log filter settings on the electronic device using OTA methods. Trace settings may include, for example, those settings described above.

In a representative embodiment of the present invention, a diagnostic/trace server such as the diagnostic server 129 may be able to collect basic device information and data connection (IP) settings from the electronic device using OTA methods.

In a representative embodiment of the present invention, a diagnostic/trace server such as the diagnostic server 129 may be able to configure data connection settings on the electronic device using OTA methods. If the data connection is incorrectly configured and TCP/IP is not available, the diagnostic/trace server may fix the GPRS data connection setting using SMS.

In a representative embodiment of the present invention, a diagnostic/trace server such as the diagnostic server 129 may permit a user to historically search through diagnostic/trace data. Search criteria may be a combination of zero or more of the following: component, sub-component, severity, device time when diagnostic/trace data is logged, and server time when log data is received, to name only a few examples.

In a representative embodiment of the present invention, a diagnostic/trace server such as the diagnostic server 129 may allow for deletion of trace data.

In a representative embodiment of the present invention, a diagnostic/trace server such as the diagnostic server 129 may allow for the export of trace data to a CSV (comma separated value) file.

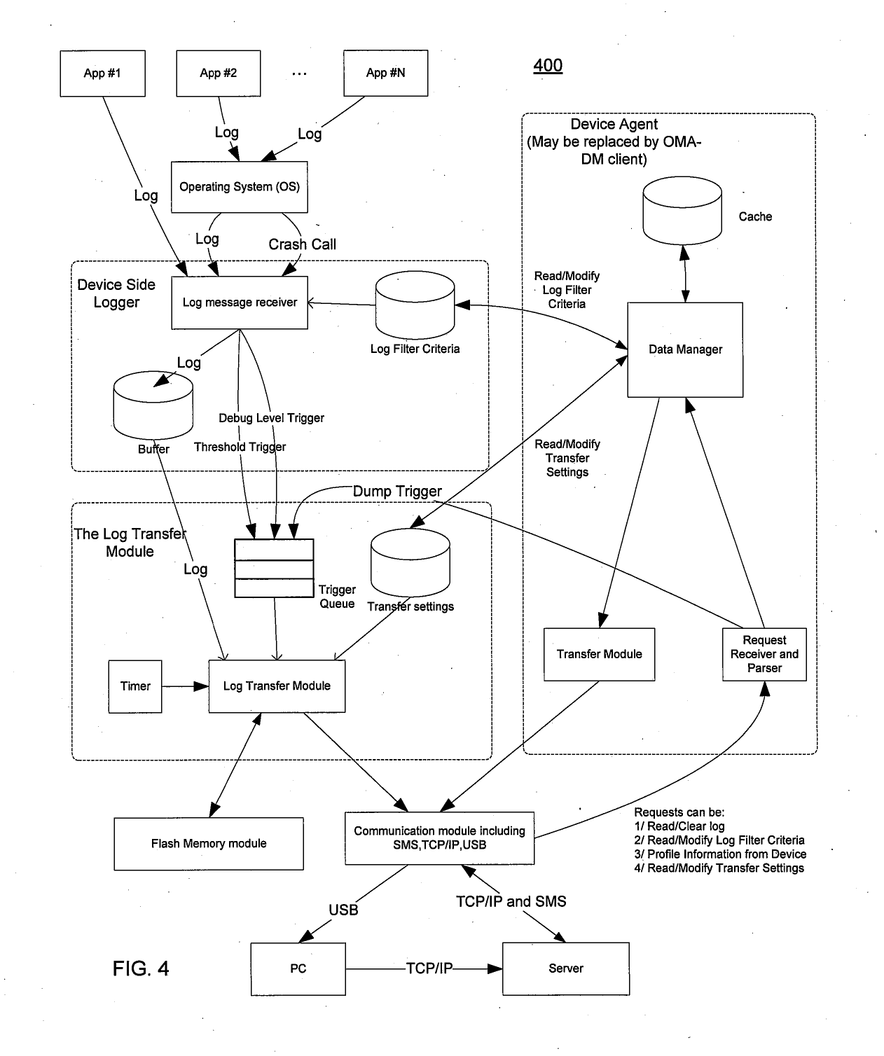

FIG. 4 shows a block diagram illustrating an exemplary diagnostic/trace client 400 that may correspond to the functionality of the diagnostic client 121 and/or diagnostic agent 171 of FIG. 1, for example, in accordance with a representative embodiment of the present invention. For ease of explanation, the diagnostic/trace client of FIG. 4 is described here in terms of the following major components, with some names changed and modules consolidated for readability:

A representative embodiment of the present invention may comprise a “Log Message Receiver”, hereinafter referred to simply as the “Logger”. The Logger may be a shared library in native processor code for the electronic device and, except for interrupts, may run in the thread of a caller. The Logger may be supported by a lower priority background thread that maybe responsible for moving log messages from RAM into internal flash memory to free up RAM log space, if space for an internal flash log has been configured. The Logger may operate in one of the following modes:
a. A small RAM buffer with a large internal flash “backup” buffer.
b. A large RAM buffer with (perhaps) no internal flash memory configured.
c. “Real-time” mode, where log messages are sent directly to a USB-attached PC, using little or no internal log buffer space (i.e., once a message is sent to the successfully, it may no longer be maintained in internal memory of the electronic device 107.)

A representative embodiment of the present invention may comprise a “Log Transfer Module”, hereinafter referred to simply as the “Uploader”. The Uploader may include associated SD card manager, USB PC communication, and server communication modules. The Uploader may be responsible for moving log messages from internal log memory to one or more external recipients. The Uploader may comprise a shared library in native processor code (e.g., for an ARM-based processor) and may run at a priority lower than the thread that moves messages from RAM to internal flash memory. In some representative embodiments of the present invention, when internal flash is configured in the electronic device (e.g., electronic device 107 of FIG. 1), it may be more important to continue to free up RAM log memory than to free up internal flash memory.

A representative embodiment of the present invention may comprise a device agent such as the diagnostic agent 171 and/or diagnostic client 121 of FIG. 1, for example. This component (e.g., in software or firmware) may comprise a transfer module and a request message receiver. The diagnostic agent/diagnostic client (E.G., diagnostic agent 171 and diagnostic client 121 of FIG. 1) may run as an application and may present an end-user interface, as necessary. In some representative embodiments of the present invention, such a diagnostic agent/diagnostic client may be written in native processor code (e.g., for an ARM-based processor).

A representative embodiment of the present invention may comprise a “Data Manager”, hereinafter referred to simply as the “Configuration Agent”. The Configuration Agent may be responsible for processing both client-initiated and server-initiated configuration requests. Such a Configuration Agent may be a separate component, or an extension to an existing device agent such as, for example, a device agent used as part of the SmartCare or FusionDM products from Bitfone Corporation, for example. The Configuration Agent may run as an application, and may present a UI as necessary.

Each of these client-side components of a representative embodiment of the present invention is described in greater detail in the following sections.

The Logger (i.e., the Log Message Receiver) in a representative embodiment of the present invention is the central logging interface for message logging for operating system (OS) components and applications. The Logger may be called by any OS or application component, and may also be called under the following special conditions:
1. Upon OS startup, after a system crash. In this case, the OS may have already saved critical log information at the time of the crash and may make a call to the Logger after the OS is restarted. No special handling by the Logger may be involved for this case, as the recovery logic may be managed by other software/firmware in the electronic device (e.g., the electronic device 107 of FIG. 1).
2. The Logger may also be called by OS code that is running at “interrupt” time. If a RAM log is in use during such a call, the log data may be captured in a dedicated “interrupt buffer” and moved into the normal log, once access to the RAM log again becomes available.

The Logger in a representative embodiment of the present invention may be capable of sustaining a peak rate of 10 KB of log data every 10 milliseconds. In some representative embodiment of the present invention, and some operating conditions, the Logger (i.e., the Log Message Receiver) may be a high duty cycle component. A C++ language function prototype for a logging call in accordance with a representative embodiment of the present invention, may look as follows:

| int TraceBinWithText | | // Main logging function |
|---|---|---|
| | (BYTE byLevel, | // Severity Level |
| | UINT32 u32Component, | // ID of component reporting the event |
| | UINT32 u32SubComp, | // ID of sub-component reporting the event |
| | UINT16 u16Datalen, | // Length of optional binary data or 0 |
| | BYTE* pbyData, | // Optional binary data or 0 (NULL) |
| | char* pszTextData ); | // Optional text data |

A representative embodiment of the present invention, several shorter versions of the above call may be provided for situations where there is no binary data, and/or no text data. A variant that provides formatting may also be provided. Formatting for messages that do not “pass” the log filter may not be done, to avoid unnecessary overhead.

The Logger of a representative embodiment of the present invention may check the following parameters upon receiving a logging request, to determine whether or not the message should be logged. This determination may be based on a set of parameters that match both the message severity and the component and sub-component pair specified by the caller. Thus, all of the following criteria may be matched before a message is logged:
1. Component and subcomponent ID—Each component of a representative embodiment of the present invention may have a unique 32-bit ID, for example, that may be commonly expressed using constants that represent readable characters (e.g., ‘COMM’). A component may consist of one or more subcomponents, identified again by, for example, a 32-bit integer. This identifier may be unique only within the context of its parent component. The Logger may treat these two parameters (i.e., component and sub-component IDs) as a pair, and the message may not be logged unless the filter contains the specific pair of component and subcomponent IDs.
2. Message Severity—Levels of message severity such as, for example, FAULT, ERROR, WARNING, INFO, and DEBUG may, for example, be represented by the values 0, 1, 2, 3, and 4, respectively. If the severity specified by a Logger call is greater than the severity level established as part of the log component and subcomponent “filter”, the message may not be logged and the Logger may return to the caller.

It should be noted that in some representative embodiments of the present invention, the severity level “FAULT” may always be logged, regardless of other criteria, as this level may only be used for the most serious of errors (e.g., where an imminent crash of an electronic device (e.g., the electronic device 107 of FIG. 1) is likely to occur).

To check whether a message should be logged, the component and subcomponent IDs may be combined as shown in the following exemplary structure, to enable look-up in a sorted list:

| struct logFilter | | // Log filter table entry |
|---|---|---|
| { | | |
| | uint64 compIDs; | // Component & subcomponent ID pair |
| | BYTE bySeverity; | // Severity level |
| | BYTE bySetTrigger; | // “1” if this message triggers an upload |

};

In some electronic devices, 64-bit integers may not be supported (e.g., on electronic devices such as those manufactured by Palm). In this instance, the following structure may be used to represent these values. In the case of component and subcomponent ID pairs, the component ID may be the “high” word, and the subcomponent ID may be the “low” word.

| | |
|---|---|
| struct uint64 | // Structure for emulating a 64-bit word |
| { | |

| | |
|---|---|
| UINT32 high; | // High 32-bits, e.g., component ID |
| UINT32 low; | // Low 32-bits, e.g., sub-component |

};

In a representative embodiment of the present invention, a single bsearch may be used to look-up the 64-bit combined component and subcomponent ID pair. If the ID pair is not found in a pre-specified list of IDs, the Logger may immediately return to the caller. If the search is successful, the value of bySeverity in the matching entry may be used to determine whether the message is to be logged. If the severity level specified by the caller is less than or equal to bySeverity, the message may be logged, otherwise the Logger may immediately return to the caller.

In a representative embodiment of the present invention, any message that passes the filter test may be used to trigger an upload of all log messages held in “internal” log storage. If the value of bySeverity has the low order bit set, the logging of this message may notify the Uploader thread to move all internal log data to an appropriate receiver external to the electronic device (e.g., the electronic device 107 of FIG. 1).

In a representative embodiment of the present invention, filter criteria and other logging parameters (e.g., log buffer sizes) may be set by a user of a handset or electronic device (e.g., the electronic device 107 of FIG. 1) using a secret key sequence to launch a logging configuration dialog described below. A server (e.g. the diagnostic server 129 or customer care server 157) may also set these same parameters over-the air using SMS messaging. The Logger of a representative embodiment of the present invention may be built with an internal default set of parameters, which are used until the parameters are reset via one of these two mechanisms.

In a representative embodiment of the present invention, component-independent event codes may be used to capture discreet events such as low/high signal or roaming transitions, for example. Event codes may be implemented using an artificial component ID ‘EVNT’, and assigning event-specific codes as subcomponent IDs. This allows a Logger call to specify the system-wide unique “event” being reported, regardless of the component actually reporting the event. An event code may be assigned to the ‘EVNT’ component for “call drop” and another for “Call Origination Failure”, for example, occurring anywhere within the handset or electronic device.

In a representative embodiment of the present invention, when real-time logging mode is enabled (i.e., turned on), logging messages may be sent directly to a USB-attached PC, and may not written to internal log memory. If the USB connection to the PC is lost, or becomes unresponsive, log messages may again be written to internal log message memory, to avoid log message data loss. If the PC connection later becomes available, real-time logging to the PC may resume, but messages written to internal memory may not automatically be sent to the PC.

In order to enable operation at the highest level of performance, the Logger of a representative embodiment of the present invention may write new log messages sequentially into a dedicated, pre-allocated circular RAM buffer in the electronic device (e.g., in RAM 165 of electronic device 107 of FIG. 1). The bytes of each log message may be written sequentially into the RAM buffer using the following exemplary format:

struct logEntry
{

| BYTE byTag; | // Designates message type and version |
|---|---|
| BYTE byLevel; | // Severity level of this message |
| UINT16 u16Sequence; | // Sequence # 1-FFFF, zero for “reset” |
| uint64 u64Time; | // Time when this event was reported |
| UINT32 u32Component; | // ID of component reporting this event |
| UINT32 u32SubComp; | // ID of sub-component reporting this |
| | event |
| UINT16 u16OptDataLen; | // Optional data length, 0 == none |
| UINT16 u16OptTextLen; | // Optional string text length, |
| | 0 == none |
| BYTE byOptData[1]; | // −> first byte of any optional data |

};

In some representative embodiments of the present invention, a 64-bit time value may be stored as two 32-bit numbers, and may represent a device-specific, high precision time value. Such time values may be in local or in UTC time, and may be subject to device user intervention. Thus, the time value may be mostly useful to record the relationship of a series of log messages that occur over a very short period of time. In a representative embodiment of the present invention, conversion of log entry time values to a more readable format may be handled by a diagnostic/trace server such as, for example, the diagnostic server 129 or the customer care server 157, of FIG. 1, not a client in the electronic device (e.g., the diagnostic client 121 of FIG. 1).

In a representative embodiment of the present invention, information may be maintained in binary form, to provide highest performance and to save message space. Indexes or other form of pointers may not be used to walk through messages. The following code example walks through all messages in the log message buffer. Note that although such functionality may be present in representative embodiments of the present invention, the following example code does not take wrap around of message in a circular buffer into account.

//-- Walk through all current log entries
int ndx = firstLogByte;
while (ndx <= lastLogByte)
{

//-- Get pointer to the next log entry in the log
logEntry* pEvt = (logEntry*) &pLog[ndx];
//-- Do something with this log entry
...
//-- Advance to the next possible log entry
ndx += (sizeof (logEntry) − 1 +
pEvt−>u32OptDataLen + pEvt−>u16OptTextLen);

}

In a representative embodiment of the present invention, a RAM buffer may be managed as a sequential, circular buffer. In situations in which there is no place to save the contents of the RAM buffer, older log entries may be sacrificed to make room for new entries. When the RAM buffer is unloaded, the entire set of messages available at the start of the unload operation may be moved to a new location, and the contiguous memory freed can then be re-used. A representative embodiment of the present invention may employ a pair of “read” and “write” mutexes, so that the uploading operation may proceed to move older log messages while the Logger is adding new entries. This approach may be employed to protected log messages from being overwritten.

In a representative embodiment of the present invention, the Logger may use a log threshold to trigger the uploading of log data, to help free space for new messages. If internal flash memory has been configured as storage for log data, the Logger may notify an Internal Flash Transfer thread to move RAM messages to internal flash memory. If there is no internal flash memory configured, the Logger may notify the Uploader to move log data to appropriate external logging target(s) (e.g., SD card or USB linked PC). This enables a representative embodiment of the present invention to continue to free RAM log space for new messages.

In a representative embodiment of the present invention, moving data from RAM to internal flash (i.e., when the electronic device is so configured) may be an ongoing process, intended to free space in a much smaller RAM buffer. In some representative embodiments of the present invention, moving data from internal memory to one or more external targets may not automatically be triggered by the movement of log data from RAM to internal flash, as the log data may still be considered “internal” to the logging service. Uploading to the external target(s) may be triggered by one of the following exemplary types of events:
1. Threshold Based—In this example, an internal log threshold (e.g., combined RAM and optional Flash size) may be reached.
2. Event Based—In this case, a specific event may have occurred for which a “trigger” flag has been set.
3. Periodic—In this example, a specified time period may have elapsed.
4. Server Requested—In this case, a server (e.g., the diagnostic server 129 or customer care server 157) may have specifically requested an immediate upload.

In a representative embodiment of the present invention, the thread that uploads internal log data (e.g., stored in RAM or internal flash memory such as RAM 165 or non-volatile memory 111, of FIG. 1) to an external recipient may run at a lower priority than the thread that moves RAM-based log data to internal flash memory. This approach may be chosen to give priority to the thread that works continuously to free RAM memory by moving data to internal flash memory. When internal flash is configured in an electronic device, log data may be moved from RAM to internal flash memory, and later from internal flash memory to an external target(s) (e.g., SD card or USB-connected PC). The Uploader may not need to access RAM log data except, for example, in the case where internal flash has not been configured in the electronic device.

In a representative embodiment of the present invention, an “Internal Flash Transfer” module may be responsible for backing up the RAM log buffer to internal flash memory to free space in the RAM buffer. This moves log data to memory that will not be lost if the battery of the electronic device (e.g., electronic device 107 of FIG. 1) is removed. The Internal Flash Transfer module may only be employed when internal flash “backup” space has been allocated in flash memory and one of the following conditions exist:
1. The amount of log data in the RAM buffer has passed a pre-determined threshold
2. A timer indicates that it is now time to move data from RAM to flash for safe keeping. Note that a “continuous mode” may be achieved by setting the time interval to zero.

In a representative embodiment of the present invention, backup flash data storage may be managed as a variable number of 64 KB files (or, for example, some other selected file size), since adding data to the end of a very long flash file can be quite time consuming. The files may be named, for example, “BK_{—}001” through “BK_xxx” to provide xxx times 64 KB of flash backup storage. If all backup files become full, the oldest backup file may be overwritten, so that only the oldest log data is lost.

In a representative embodiment of the present invention, each backup file may contain a set of contiguous and complete log messages, preceded by a message header. The message header may be completely filled when the final size is known. An exemplary message header is described elsewhere herein. In some representative embodiment of the present invention, log messages may not be split across files. It may be permissible to exceed the 64 KB file size (or, for example, some other selected backup file size) to complete a log message, but once a file exceeds 64 Kb, no more messages may be added to it. Each 64 KB file may be maintained in the format in which it will be transferred to an external target(s) (e.g., SD card, USB link PC, remote server via OTA).

In a representative embodiment of the present invention, the operating system of an electronic device (e.g., the electronic device 107 of FIG. 1) may provide an ever-increasing boot number that may be written into the log message transfer header. Whenever this boot number is observed to be different than the last boot number recorded by the Internal Flash Transfer thread, a new flash file may be started with the new boot number written into the log message transfer header.

As each block of log memory is moved to internal flash memory, the current flash file size maintained in the file directory may be used to determine where to write the next block of log information. This value may be cached for efficiency, but any cached value may be discarded when the electronic device is rebooted. A representative embodiment of the present invention may handle a system crash or power loss that results in a corrupted directory entry. The flash file system may only update file length after the information is successfully written to flash memory.

In a representative embodiment of the present invention, writing to the RAM buffer (e.g., in RAM 165 of FIG. 1) may be protected by a mutex, to prevent two or more threads from writing to the RAM buffer at the same time. The holding time for this mutex may be kept to an absolute minimum, and may protect only the period of time necessary to write the bytes into the RAM buffer and update any counters used. More extensive processing may be done on the stack of the calling thread.

In some representative embodiments of the present invention, when the Logger is called by an Interrupt thread (e.g., using an interrupt-specific entry point), special handling may be involved (e.g., for the Palm OS). When the Logger is operating during an interrupt, it may try to obtain the log mutex, but may not be able to “wait” for it if another thread has it. In such a case, the Logger may use a dedicated “interrupt buffer” to store the log data. In a representative embodiment of the present invention, memory space may be provided for such interrupt messages (e.g., five messages). If such memory space is exceeded, interrupt data may be lost.

When the Logger releases the RAM buffer mutex, it may check to see if any log messages have been placed in the interrupt buffer, and if so, may moves them into the main RAM buffer to free the interrupt buffer space. When updating any counters that control the interrupt buffer, the Logger may briefly suspend interrupts. The method for suspending interrupts may be specific to the manufacturer of the electronic device, to prevent data corruption of these counters.

In a representative embodiment of the present invention, the main Logger code may be written in native code for the processor of the electronic device (e.g., for an ARM-based processor in electronic devices that use a processor from ARM, Ltd.). An exemplary native code interface to the Logger is represented by the following function prototypes:

| int SetFilters | | // Set trace filtering criteria |
|---|---|---|
| | (logFilter* pFilter, | // List of components+sub-components to log |
| | int nFilter ); | // .. including severity and trigger flag) |

The format of the filter list may be as follows:

| struct logFilter | | // Format of a single filter list entry |
|---|---|---|
| { | | |
| | uint64 compIDs; | // Component + subcomponent ID pair |
| | BYTE bySeverity; | // Severity level |
| | BYTE bySetTrigger; | // ‘1’ if this message triggers an upload |

};

The format of function prototypes for Logging functions may be as follows:

| BOOL TraceFilter | | // Test if a given message will be logged |
|---|---|---|
| | ( BYTE byLevel, | // Severity Level |
| | UINT32 u32Component, | // ID of component reporting the event |
| | UINT32 u32SubComp ); | // ID of sub-component reporting the event |
| int TraceBinWithText | | // Main logging function |
| | (BYTE byLevel, | // Severity Level |
| | UINT32 u32Component, | // ID of component reporting the event |
| | UINT32 u32SubComp, | // ID of sub-component reporting the event |
| | UINT16 u16Datalen, | // Length of optional binary data or 0 |
| | BYTE* pbyData, | // Optional binary data or 0 (NULL) |
| | char* pszTextData ); | // Optional text data |
| int TraceBinFormat | | // Log full message with formatted text |
| | (BYTE byLevel, | // Severity Level |
| | UINT32 u32Component, | // ID of component reporting the event |
| | UINT32 u32SubComp, | // ID of sub-component reporting the event |
| | UINT16 u16Datalen, | // Length of optional binary data or 0 |
| | BYTE* pbyData, | // Optional binary data or 0 (NULL) |
| | char* pszFormat, | // Optional format statement |
| | ... ); | // Optional sprintf parameters |
| int TraceFormat | | // Log message with formatted text only |
| | (BYTE byLevel, | // Severity Level |
| | UINT32 u32Component, | // ID of component reporting the event |
| | UINT32 u32SubComp, | // ID of sub-component reporting the event |
| | char* pszFormat, | // Optional format statement |
| | ... ); | // Optional sprintf parameters |
| int TraceText | | // Log message with string text only |
| | (BYTE byLevel, | // Severity Level |
| | UINT32 u32Component, | // ID of component reporting the event |
| | UINT32 u32SubComp, | // ID of sub-component reporting the event |
| | char* pszTextData ); | // Optional text data |
| int TraceBin | | // Log message with binary data only |
| | (BYTE byLevel, | // Severity Level |
| | UINT32 u32Component, | // ID of component reporting the event |
| | UINT32 u32SubComp, | // ID of sub-component reporting the event |
| | UINT16 u16Datalen, | // Length of optional binary data or 0 |
| | BYTE* pbyData); | // Optional binary data or 0 (NULL) |
| int TraceEvent | | // Log simple event message |
| | (BYTE byLevel, | // Severity Level |
| | UINT32 u32Component, | // ID of component reporting the event |
| | UINT32 u32SubComp ); | // ID of sub-component reporting the event |

In a representative embodiment of the present invention, code written for a first processor platform may be re-used on a second processor platform using a set of “shim” functions that allow calls to native code functions on the second processor. Such shim functions may convert parameters and other calling conventions to be compatible with the native Logger functions of the second processor platform, for processing. Conversion of big Endian to little Endian format may also performed by the shim functions, such that the Logger may always receive parameters in native processor format (e.g., for an ARM processor, little Endian).

In a representative embodiment of the present invention, the following variation of the above logging calls may be used (e.g., for code in electronic devices manufactured by Palm) that is running at interrupt time.

| int TraceOnInterrupt | | // Logging function for interrupts only |
|---|---|---|
| | (BYTE byLevel, | // Severity Level |
| | UINT32 u32Component, | // ID of component reporting the event |
| | UINT32 u32SubComp, | // ID of sub-component reporting the event |
| | UINT16 u16Datalen, | // Length of optional binary data or 0 |
| | BYTE* pbyData, | // Optional binary data or 0 (NULL) |
| | char* pszTextData ); | // Optional text data |

The Logger in a representative embodiment of the present invention, upon receiving this call may know that the Logger is being called at interrupt time, and that use of the interrupt specific logic detailed above is appropriate.

In a representative embodiment of the present invention, the following exemplary entry point may be used to enumerate (i.e., list) currently available log entries in internal log memory, RAM and internal flash memory:

| int EnumLogEntries | | // Enumerate log entries |
|---|---|---|
| | (void Function (logEntry*) ); | // User specified callback function |

In some representative embodiments of the present invention, this function may enumerate only the contents of the RAM log buffer. In other representative embodiments of the present invention, more full support may be provided.

In a representative embodiment of the present invention, the Uploader may be responsible for the actual transfer of log data from internal device storage (e.g., in RAM 165 or flash memory such as the non-volatile memory 111, of FIG. 1) to one or more external targets. The Uploader may run at a lower priority than the thread that transfers RAM log data to internal flash memory. Thus, when internal flash is configured, the Uploader works by moving internal flash log files to the appropriate external targets. When no internal flash is configured in an electronic device, the Uploader may work by moving log data from the RAM buffer (e.g., RAM 165) directly to the external targets (e.g., an SD card, a USB linked PC, or a remote server via OTA). Depending on the presence or absence of internal flash memory, the Uploader may either:
1. move data directly from RAM to the external targets, when there is no internal flash configured in the electronic device, or
2. move data (e.g., flash files) from internal flash memory to external targets, when internal flash is configured in he electronic device.

Since the Uploader may run at lower priority than the thread that transfers RAM log data to internal flash memory, and since that move to internal flash memory may be non-blocking, the log data to be transferred externally may already have been stored as files in internal flash memory.

In a representative embodiment of the present invention, such external transfers may result from some type of trigger, accompanied by a notification (e.g., a mailbox message) to the Uploader thread. The various triggers may be specified in an Internal Log Memory Management section, as described above. Triggers may be pre-specified during Logger configuration, or may result from an explicit SMS message request from diagnostic/trace server such as, for example, the diagnostic server 129 or customer care server 157, of FIG. 1. The Uploader may service each transfer trigger using one or more of the following transfer methods as selected during Logger configuration, in the following exemplary priority order:
1. Transferring the data to the diagnostic/trace server OTA using TCP/IP,
2. Transferring the data to an attached PC via a USB connection,
3. Writing the data to an external SD card.

In each of the above cases, a Log Transfer module may use one of the components described below to accomplish the actual data transfer, but may maintain control of the overall transfer process. The Log Transfer module may establish a data connection when needed for data transfer to a server such as, for example, the device management server 109, the diagnostic server 129 or the customer care server 157, and will take precautions to not interrupt an existing voice connection when establishing the needed data connection. The Uploader may minimize the data connection and transfer times in order to minimize the visible impact to the user, since on some electronic devices, voice calls cannot be made while a data connection is in session.

In some representative embodiment of the present invention, multiple targets may be selected. For this reason, the Uploader may move data in 64K blocks (i.e., the same as internal flash file size) to each selected target in a priority order. For example, if both the USB transfer to PC and SD card options are selected, and there are three (3) 64K files sitting in internal flash memory, the following exemplary transfer sequence may be used:
1. 1st 64K block to the PC,
2. 1st 64K block to SD,
3. 2nd 64K block to the PC,
4. 2nd 64K block to SD,
5. 3rd 64K block to the PC,
6. 3rd 64K block to SD.

If one of several targets is unavailable for any reason, but another target is currently available, data may be written to the available target. The unavailable target may not receive the lost log data. A representative embodiment of the present invention may not attempt to preserve data for an unavailable target, when other targets are available. However, if no selected target is available (e.g., only an unavailable target is selected), the log data may be retained within internal flash memory of the electronic device (e.g., the electronic device 107 of FIG. 1). Once log data is transferred successfully to at least one target, the log data may be released from memory of the electronic device.

Note that in a representative embodiment of the present invention, the 64K value is an exemplary threshold, not a precise, fixed unit of data transfer. Since a log message may not be allowed to be split across internal flash files or transfer message blocks, it may be acceptable for some transfer messages to be a bit larger than 64K, to the extent that the last log message in the buffer crosses the 64 KB threshold. Each unit of log message transfer may be prefixed with the following exemplary message header:

struct msgHeader
{

| UINT16 u16MsgVersion; | // Message format version |
|---|---|
| UINT16 u16MsgType; | // Message type |
| UINT16 u16DevType; | // Device type |
| UINT16 u16DevVersion; | // Device version, most likely the |
| | SW version |
| UINT32 u32MsgLength; | // Message length, INCLUDING this |
| | header |
| uint64 u64DeviceTime; | // Device dependent time of this |
| | message |
| INT16 i16UTCOffset; | // Local time offset from UTC in |
| | minutes |
| UINT16 u16BootNumber; | // Increments each time device is |
| | rebooted |
| char szEventID; | // SmartCare Event ID, zero |
| | terminated |
| char szDeviceID; | // Device ID e.g., IMEI/ESN, zero |
| | terminated |
| char szMSISDN; | // MSISDN or empty string, zero |

terminated

};

In some representative embodiments of the present invention, when a new internal flash file is written, a complete header may be written to the front of the log file. In this case, the final file size may not be known until the last set of log messages is written. Until the final file size is known, the value of the header element u32MsgLength may be set to zero. When moving log files to an external target, Upload may copy the header from the flash file, fill in the message (i.e., file) length, transfer (e.g., write) the corrected header to the target followed by the log data, which may be written directly from flash memory. In the case where no internal flash memory has been configured, the Uploader may format the above header information directly from the RAM log data.

In a representative embodiment of the present invention, a boot number, maintained by the OS, may be placed in the header at the time the header is first created. When using internal flash memory, the change of a boot number may start a new log file. The time value may be device specific may be in a device-specific precision, and it may represent either device local time or UTC time. At the time the transfer header is created, the device time and a value representing the number of minutes offset from UTC may be calculated as show by the following exemplary sequence:
1. Local time is read from the OS (e.g., in seconds),
2. UTC (e.g., in seconds) is calculated using available platform services,
3. UTC time is subtracted from local time, and divided by 60 seconds,
4. The resulting value is placed in the header as i16UTCOffset.

The reason this may be done at header creation time, rather than at log time, is that the conversion from local to UTC (or vice versa) may require access to preferences that may be stored in flash memory of the electronic device. Access to the flash memory may dramatically slow down the Logger when writing new log messages to the RAM log buffer.

The Uploader in a representative embodiment of the present invention may make use of one or more of the following exemplary modules to move data to the selected external target(s):
1. A Server Communications Module may write the log data to a diagnostic/trace server such as, for example, the diagnostic server 129 or customer care server 157. In this case, a device management server such as the device management server 109, a diagnostic server such as the diagnostic server 129, and/or a customer care server such as the customer care server 157, for example, may used to properly configure the electronic device for OTA communication.
2. A PC Communications Module may write the log data directly to a USB attached PC, in units of “64K” files/messages.
3. An SD Card Manager may write data to an SD card as series of “64K” files, which may later be imported to a PC for processing, and possible later upload from the PC to a diagnostic/trace server such as the diagnostic server 129, for example. Note that when moving data from internal flash memory to an SD card, a series of file copies may be used, in which the value of u32MsgLength in the file/message header is updated from the flash file directory entry.

In a representative embodiment of the present invention, a Server Communications Module may contain low level code to support wireless communication over TCP/IP and HTTP. This module may be responsible the API's and protocol specifics employed to transfer each unit of “64K” log data reliably. Note that although SMS may be used for handset configuration and control, SMS may not be appropriate and may not be used for transferring large amounts of binary log data. For OS platforms that support TCP/IP over USB, this module may be used for USB data transfers as well to a USB attached PC.

Some electronic devices (e.g., some Palm OS-based electronic devices) do not have an HTTP interface for communication using the HTTP protocol. Such electronic devices may provide a file transfer interface used to move 64 KB files between the electronic device and a PC over a USB interface. It appears likely that the means of communication between an electronic device or handset and a PC will vary depending on the electronic device platform. In any case, in a representative embodiment of the present invention, the actual binary log information transferred may be exactly the same content and format as when communicating over the Internet, exclusive of protocol specifics.

In a representative embodiment of the present invention, a different interface may be used between an electronic device (e.g., electronic device 107 of FIG. 1) and a PC, when operating in a “real-time” mode. For example, in some cases, a manufacturer of an electronic device may provide a remote procedure call (RPC)-like interface that is to be used to communicate real-time between the electronic device and the PC over a USB link.

In a representative embodiment of the present invention, when a diagnostic/trace client such as the diagnostic client 121 is first in operation, it may not know how to communicate with its server. A diagnostic/trace client such as the diagnostic client 121, for example, may employ a subset of the IP configuration settings of a customer care system such as those used to communicate with a device management server, diagnostic server, or customer care server such as, for example, the device management server 109, diagnostic server 129 or customer care server 157 of FIG. 1, to establish OTA connectivity to such a server. This information may be pre-provisioned at the time of manufacture, or be configured OTA from the diagnostic/trace server. In a representative embodiment of the present invention, a subset version of a standard device management client or provisioning client such as the device management client 163 and provisioning client 123 of FIG. 1 may be used to manage the OTA configuration settings from the diagnostic/trace server. Note that such a device agent, and components of the diagnostic/trace client may be downloaded to the electronic device, or embedded in the electronic device, using standard build and manufacturing procedures.

Until an electronic device (e.g., electronic device 107 of FIG. 1) is configured, either by a user from, for example, a configuration dialog screen on the electronic device/handset, or via a diagnostic/trace server OTA, the trace service may operate using a minimal set of default device settings. The Logger may be re-configured, for example, via either an SMS message from the diagnostic/trace server, or via a local configuration dialog screen on the electronic device/handset, that may be activated/invoked using a ‘secret’ keystroke sequence on the electronic device. The Logger configuration dialog screen may present the user of the electronic device/handset with a list of built-in component names and IDs, and allow the user to select, for example, the component and subcomponent ID pairs that the user wants to log, the severity level to be logged, and whether or not such an event should trigger an upload of log information. If all the subcomponents of a given component are to have their messages logged, each subcomponent may be selected. To make this easier for the user, a simple “check all” capability may be provided.

In a representative embodiment of the present invention, such a configuration dialog screen may allow component and subcomponent IDs (e.g., ‘COMM’ and ‘RECV’) to be entered directly, to be able to activate (i.e., turn on) logging for components that have not identified themselves to an OS loader. Once the user has selected a set of component and subcomponent filters, a new filter list may be passed to the Logger via the SetFilters function described above, along with the user-selected severity level.

The configuration dialog screen may also provide a means for reconfiguring other Logger parameters such as, for example, the amount of RAM and internal flash memory to be allocated to the Logger. Note that reducing the amount of memory allocated to the Logger may result in the loss of some older log data.

The device-side logger configuration dialog may be seen as an extension of the existing log configuration dialog.

In a representative embodiment of the present invention, a diagnostic/trace server such as the diagnostic server 129 may used for collecting and persisting log data from groups of electronic devices (e.g., the electronic device 107 of FIG. 1), and for OTA configuration of device-side diagnostic/trace settings.

A diagnostic/trace server in a representative embodiment of the present invention may make use of functionality of a customer care server such as the SmartCare or FusionDM customer care server available from Bitfone Corporation, for example, for OTA collection and modification of diagnostic/trace settings on the devices. The diagnostic/trace server may initiate a collection or configuration request on an electronic device (e.g., electronic device 107 of FIG. 1), by sending a special SMS notification to the electronic device. Upon receiving the notification, the electronic device agent (e.g., a device agent, a diagnostic agent such as the diagnostic agent 171 of FIG. 1, a provisioning client such as the provisioning client 123 of FIG. 1, or a diagnostic client such as the diagnostic client 121 of FIG. 1) may wake up, may collect and/or configure electronic device settings, and may automatically attempt the most efficient delivery method (i.e. TCP/IP) to transfer data back to the diagnostic/trace server. If TCP/IP connectivity is not available, the device agent may automatically revert to using SMS.

A diagnostic/trace server in accordance with a representative embodiment of the present invention, such as the diagnostic server 129, for example, may also be responsible for receiving and persisting log data collected on an electronic device like the electronic device 107 of FIG. 1. Such log data/information may, for example, come from two channels: 1) directly from the electronic device or, 2) from a PC application. Because of the potential size of log data, it may not be practical to use SMS as a transport mechanism. Instead, the log data/information may be transferred to the server using a TCP/IP transport mechanism.

A diagnostic/trace server in a representative embodiment of the present invention may be implemented, for example, as a J2EE (Java Version 2.0, Enterprise Edition) application with a web-based user interface. A Struts Action framework may be used for building the web-based user interface. The application server used may be JBoss Application Server 4.0.3 SP1, available from Red Hat, Inc., and the database used may be Oracle 91 or higher, available from Oracle.

In a representative embodiment of the present invention, a subscriber may be a mobile phone account owner in a wireless carrier network, and may be characterized, for example, by a mobile number. Subscribers that have common characteristics may belong to the same Subscriber Class. An electronic device may be a mobile/cellular phone, a wireless-capable personal digital assistant or a pager, and may be characterized by an IMEI/ESN. A subscriber may have one or more electronic devices, but there may be only one ‘last known device’ associated with each subscriber. A user may be a person who logs in to a diagnostic/trace system to retrieve electronic device trace logs and to perform other administrative tasks. There may be two types of users in the system—a Super User and a Regular User.

In a representative embodiment of the present invention, each user may belong to a user group, and each user group may be allowed to manage subscribers belonging to one or more Subscriber Classes. A user may only be allowed to view and manage those subscribers that his/her user group has access to. The Super User may belong to a special DEFAULT user group, and may have access to all subscribers and functionality within the system.

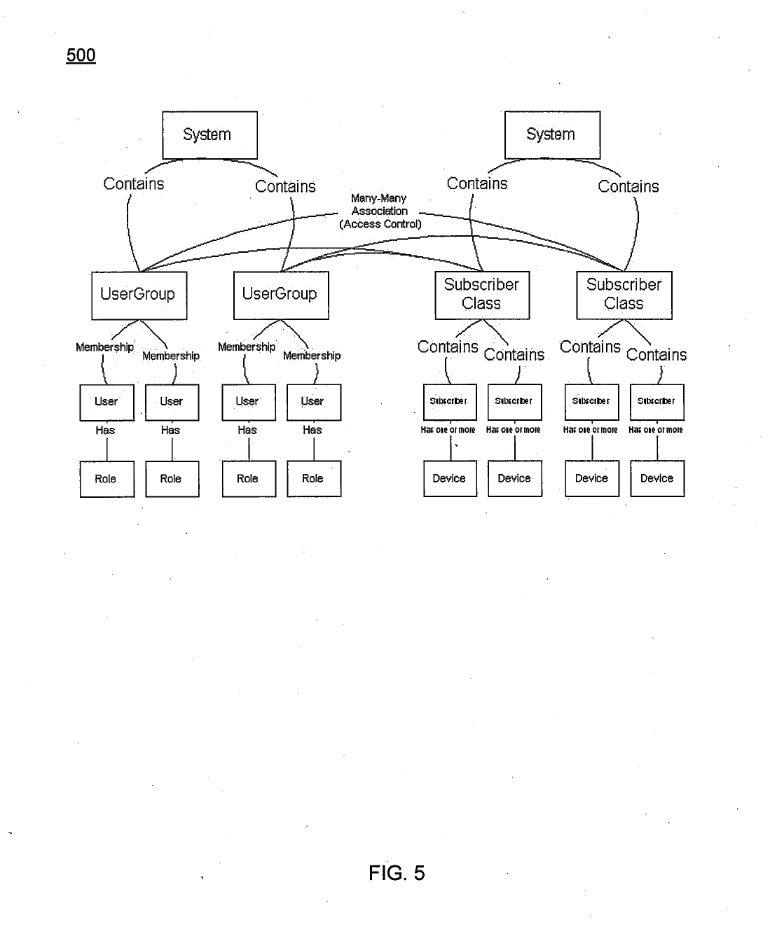

FIG. 5 is a block diagram illustrating the relationships between Users, User Groups, electronic devices, Subscribers, and Subscriber Classes, in accordance with a representative embodiment of the present invention. In some representative embodiments of the present invention, all users may be granted the Super User role. In addition, all Users may belong to the same User Group and all Subscribers may belong to the same Subscriber Class. In such an embodiment, all Users may be able to view all Subscribers and Devices in the system. In other representative embodiments of the present invention, limitations may be placed upon the role of Users, Users may belong to a number of individual User Groups, and the Subscribers may be spread across a number of Subscriber Classes. In such a system, greater protection of User, User Group, Subscriber and Device information may be provided.

In a representative embodiment of the present invention, a user may, for example, have the following properties: Login Name, Password, First Name, Last Name, Email, Work Phone, Mobile Phone, User Group, Time Zone, and Description. In some representative embodiments of the present invention, a default User Group may be preloaded into the database and a Group dropdown menu may only show the preloaded User Group. A representative embodiment of the present invention may employ web page user interface screens for searching, creating, editing and deleting Users from the database.

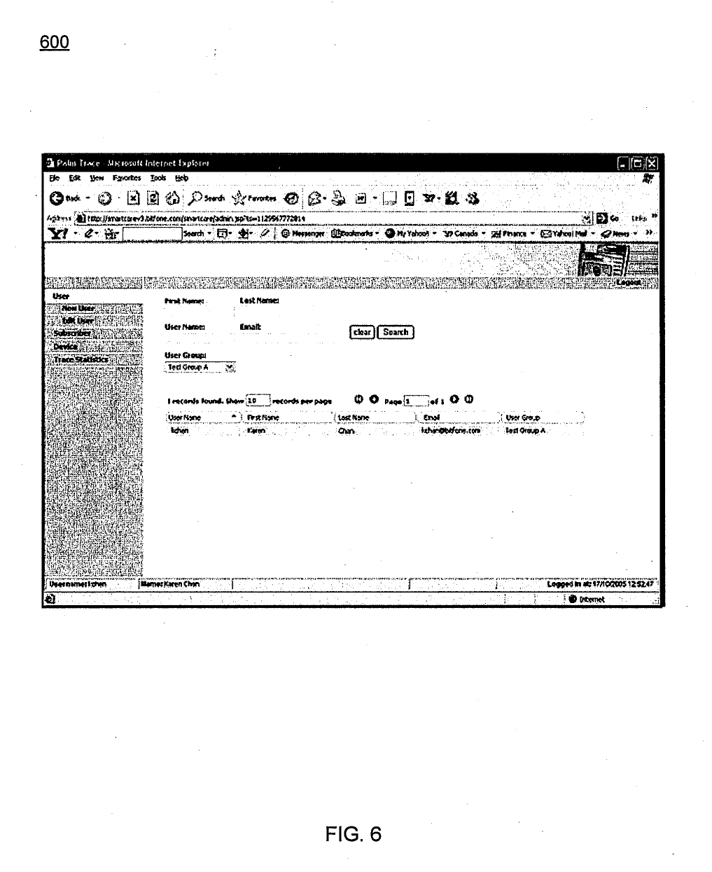

FIG. 6 illustrates an exemplary web page user interface screen 600 for searching a database of Users, in accordance with a representative embodiment of the present invention.

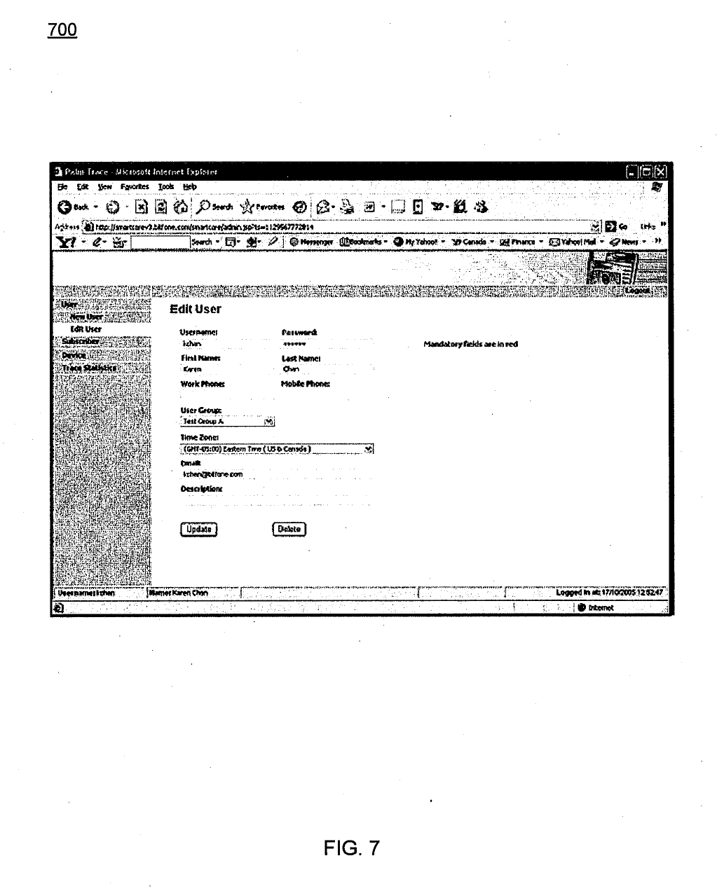

FIG. 7 illustrates an exemplary web page user interface screen 700 for editing entries in a database of Users, in accordance with a representative embodiment of the present invention.

In a representative embodiment of the present invention, a subscriber may, for example, have the following properties: Subscriber Class, First Name, Last Name, MSISDN, Email, Home Phone Number, and Address. In some representative embodiments of the present invention, a Subscriber Class may be preloaded into the database and the Subscriber Class dropdown may only show the preloaded Subscriber Class. A subscriber may also have one or more devices. However, there may only be one “Last Known Device” associated with a subscriber. In a representative embodiment of the present invention, there may be web page user interface screen for searching, creating, editing, deleting and importing Subscribers.

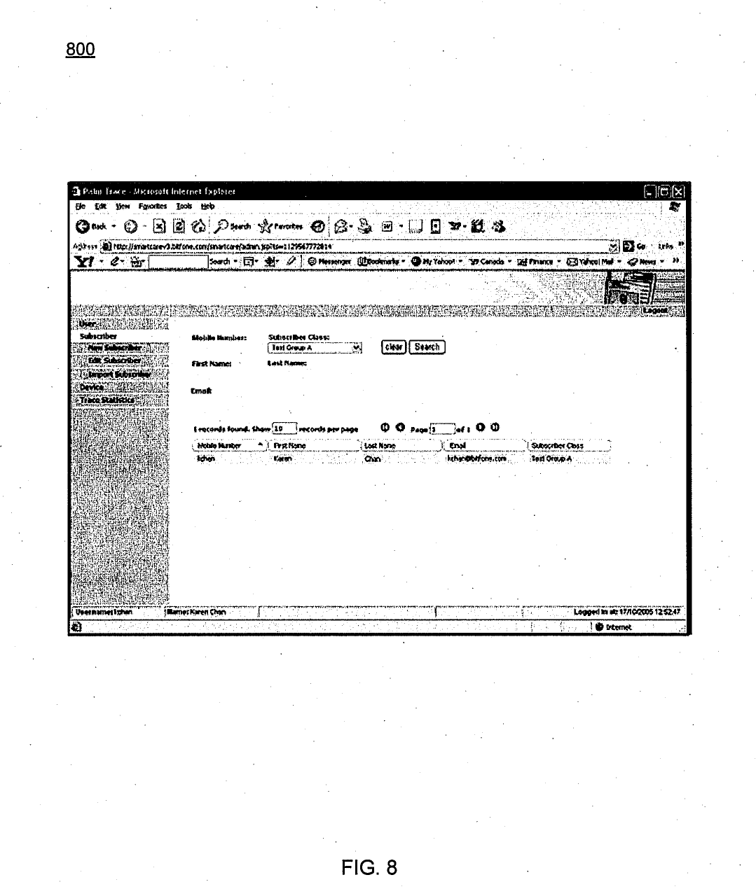

FIG. 8 illustrates an exemplary web page user interface screen 800 for searching a database of Subscribers, in accordance with a representative embodiment of the present invention.

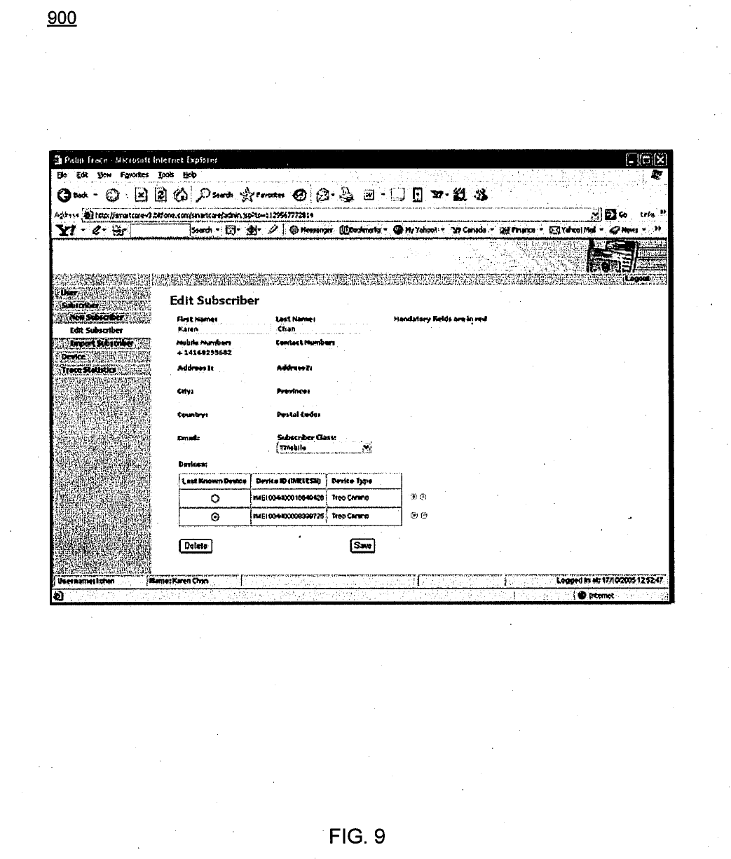

FIG. 9 illustrates an exemplary web page user interface screen 900 for editing entries in a database of Subscribers, in accordance with a representative embodiment of the present invention.

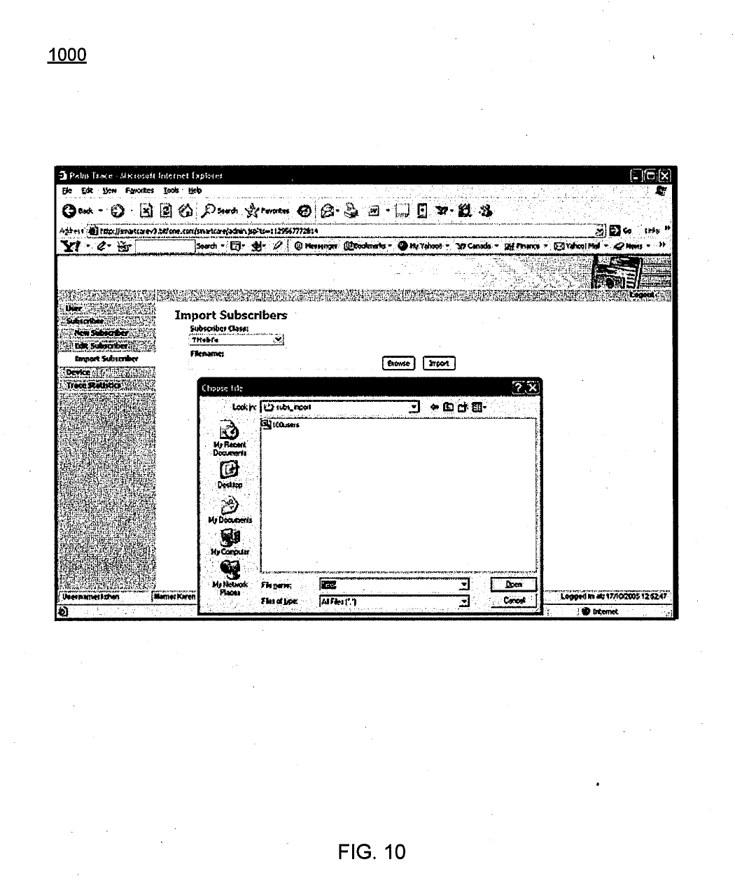

FIG. 10 illustrates an exemplary web page user interface screen 1000 for importing Subscriber information into a database of Subscribers, in accordance with a representative embodiment of the present invention.

To import a list of Subscribers and to associate them with an electronic device, a User may, for example, click on Browse, select a CSV file from the file system, and click Import. The CSV file may, for example, be in the following format:
[mobile number1][optional IMEI/ESN1]
[mobile number2][optional IMEI/ESN2]
. . .

If the IMEI/ESN is supplied, the system may try to associate the Subscriber with the electronic device. If the IMEI/ESN is not supplied or is not found in the system, the system may only create a Subscriber record.

In a representative embodiment of the present invention, a Device may, for example, have the following properties: Device ID (IMEI/ESN), Device Type, Description and Associated Subscriber. All Device Types may be preloaded into the diagnostic/trace database.

In a representative embodiment of the present invention, a Device may, for example, be created in one of at least two ways:
1. Manually—by a user using a user interface on diagnostic/trace server such as, for example, the diagnostic server 129 of FIG. 1, or
2. Automatically—when trace data is sent back to the server, if the electronic device has not been registered in the system.

In a representative embodiment of the present invention, there may, for example, be screens for Searching, Creating, Editing, Deleting and Importing devices. Since the unique identifier of a Device is the Device ID, the Device ID is not editable once the device is created.

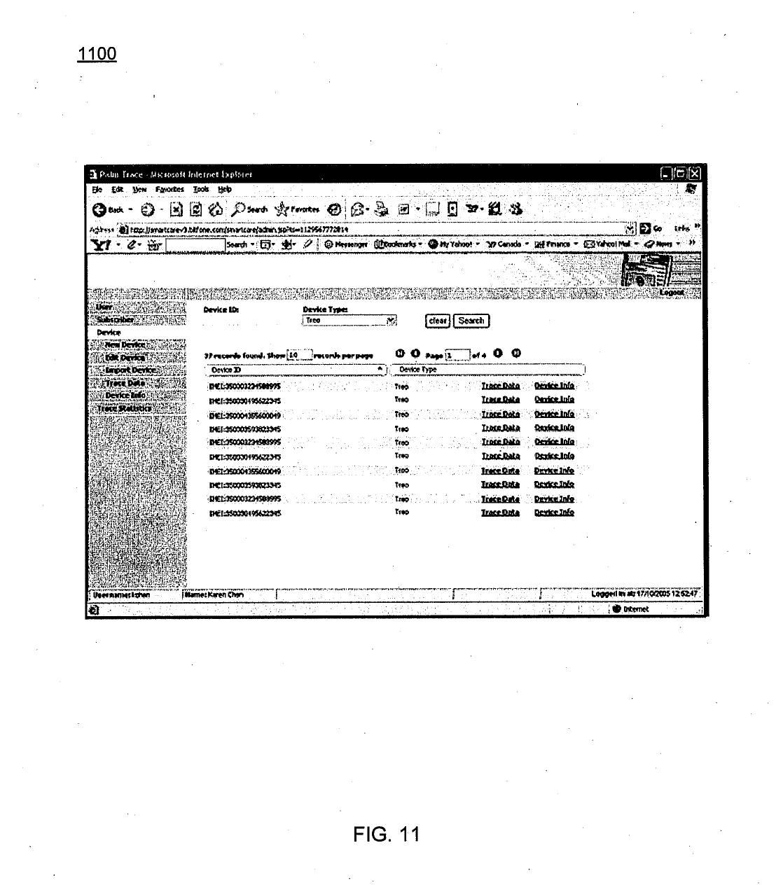

FIG. 11 illustrates an exemplary web page user interface screen 1100 for searching a database of Devices that may correspond to, for example, electronic device such as the electronic device 107 of FIG. 1, in accordance with a representative embodiment of the present invention.

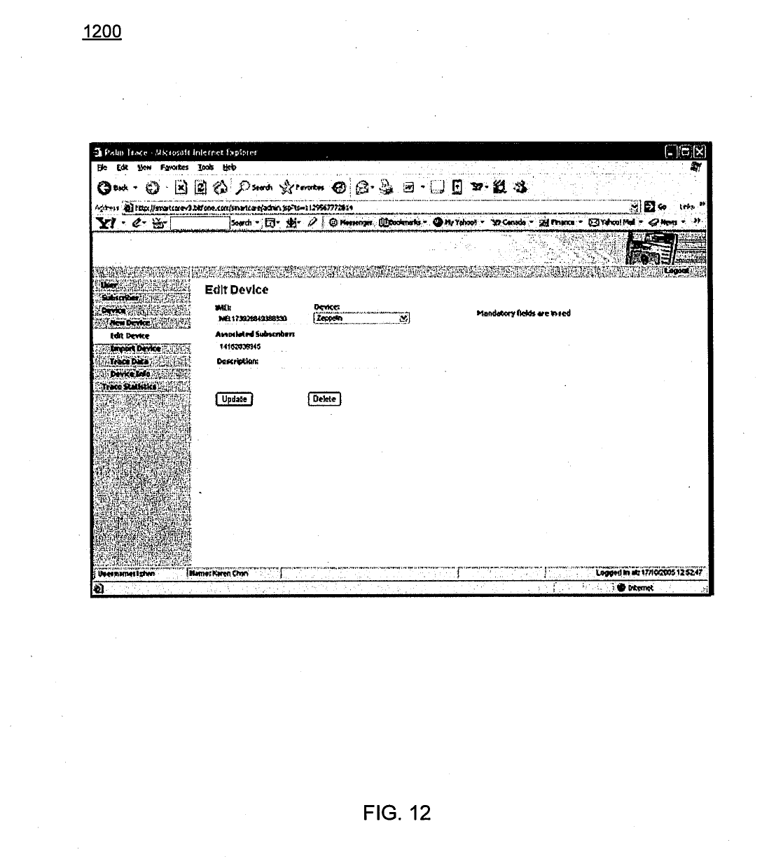

FIG. 12 illustrates an exemplary web page user interface screen 1200 for editing entries in a database of Devices that may correspond to, for example, electronic device such as the electronic device 107 of FIG. 1, in accordance with a representative embodiment of the present invention. In a representative embodiment of the present invention, the Associated Subscriber may not be editable in the Edit Device screen, since the association of a Device with a Subscriber may be performed in the Edit Subscriber screen.

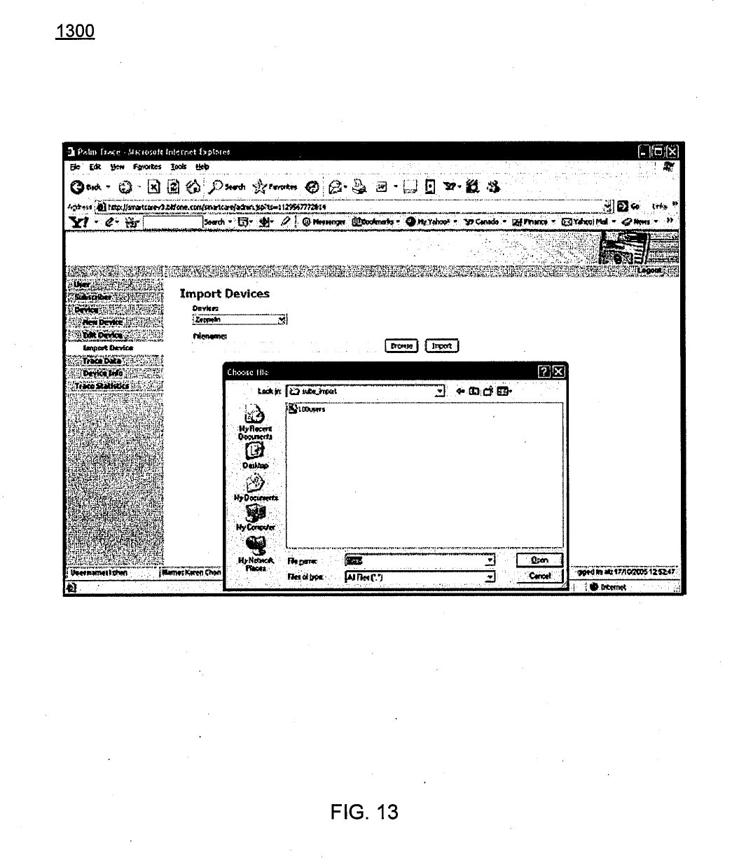

FIG. 13 illustrates an exemplary web page user interface screen 1300 for importing Device information into a database of Devices that may correspond to, for example, electronic device such as the electronic device 107 of FIG. 1, in accordance with a representative embodiment of the present invention. To import a list of devices, a user may, for example, click on Browse, select the appropriate CSV file from the file system, and click Import. The CSV file may, for example, be in the following format:
[IMEI/ESN1]
[IMEI/ESN2]

In a representative embodiment of the present invention, diagnostic/trace data may be logged on an electronic device (e.g., electronic device 107 of FIG. 1) and transferred back to a server such as the diagnostic server 129 of FIG. 1, for example, either through the device itself or through a PC application. Each diagnostic/trace data transfer session may be for a unique boot number for a single electronic device, and may not contain any partial log entries. The log data may be transferred to the diagnostic/trace server using the HTTP protocol, and may use a byte-range in the HTTP header. The user-agent information in the HTTP header may indicate the source (e.g., “PCApp” or “TraceClient”). The log data portion of the HTTP request may start with a log message transmission header, followed by one or more log entries.

In a representative embodiment of the present invention, the structure of a log message transmission header may be as shown in the following example:

struct msgHeader
{

| UINT16 u16MsgVersion; | // Message format version |
|---|---|
| UINT16 u16MsgType; | // Message type |
| UINT16 u16DevType; | // Device type |
| UINT16 u16DevVersion; | // Device version, most likely the |
| | SW version |
| UINT32 u32MsgLength; | // Message length, INCLUDING this |
| | header |
| uint64 u64DeviceTime; | // Device dependent time of this |
| | transfer. |
| // Note, this is actually a structure | |
| // containing two UINT32 | |
| INT16 i16UTCOffset; | // Local time signed offset from |
| | // UTC in Minutes. If the offset is |
| | // 0, it means that the device is |
| | // already sending the device local |
| | // time in the log entries |
| UINT16 u16BootNumber; | // Increments each time device is |
| | rebooted |
| char szEventID; | // SmartCare Event ID, zero |
| | terminated |
| char szDeviceID; | // IMEI/ESN or other device ID, |
| | zero terminated |
| char szMSISDN; | // MSISDN or empty string, zero |

terminated

};

In a representative embodiment of the present invention, the structure of a log entry may be as shown in the following example:

struct logEntry
{

| BYTE byTag; | // Designates message type and version |
|---|---|
| BYTE byLevel; | // Severity level of this message |
| UINT16 u16Sequence; | // Message sequence from 1-FFFF, zero |
| | for “reset” |
| uint64 u64Time; | // Device dependent time of this message. |
| | // Note, this is actually a structure |
| | // containing two UINT32 |
| UINT32 u32Component; | // ID of component reporting this event |
| UINT32 u32SubComp; | // ID of sub-component reporting this |
| | event |
| UINT16 u16OptDataLen; | // Optional data length, 0 == none |
| UINT16 u16OptTextLen; | // Optional string text length, |
| | 0 == none |
| BYTE byOptData[1]; | // Locates the first byte of any |

optional data.
// Binary data comes first, followed
by text

};

In a representative embodiment of the present invention, the server side may comprise a servlet, a Java Message Service (JMS) Queue and a JMS Listener for receiving trace data. For performance reasons, the servlet may have minimum processing logic. In some representative embodiments of the present invention, the servlet may just read the entire binary data stream, parse the message length in the header, and compare the total transmission data length. If the lengths do not match, a special HTTP status code, 400—Bad Request, may be returned. If the lengths match, the servlet may queue the data into the JMS Queue for further processing and return HTTP status code 200 (Success).

In a representative embodiment of the present invention, a diagnostic/trace data transfer session may be server-initiated by a User requesting a diagnostic/trace data dump on an electronic device, or may be client-initiated when a timer or buffer condition fullness is met on the electronic device, or when a PC application sends electronic device data back to a diagnostic trace server such as the diagnostic server 129 of FIG. 1. If a request is server-initiated, the resulting diagnostic/trace data transfer may include an original event ID in the message transmission header. If a request is client-initiated, the resulting diagnostic/trace data transfer may include 0 (zero) as the event ID in the message transmission header, and the diagnostic/trace server may generate an event ID for grouping all log entries received.

In a representative embodiment of the present invention, the JMS Listener may receive the message from the JMS Queue as a javax.jms.ObjectMessage. The JMS Listener may then parse the log data into individual diagnostic/trace log entries and write them persistently into the database.

In some representative embodiments of the present invention, duplicate diagnostic/trace data may result when both a PC Application and the electronic device (e.g., electronic device 107 of FIG. 1) are attempting to send back diagnostic/trace data to the diagnostic/trace server. The diagnostic/trace server may be responsible for ignoring duplicate diagnostic/trace data received from the electronic device. The diagnostic/trace server may use a Device Instance ID, Boot Number, Sequence Number, Device Time, Component, Subcomponent, and Severity in the log entry to determine whether a log entry is duplicated. When checking for duplicates, the diagnostic/trace server may not compare the binary or text data in the log, to avoid performance problems.

In a representative embodiment of the present invention, a diagnostic/trace server such as, for example, the diagnostic server 129 of FIG. 1 may store all diagnostic/trace log data into an SC_TRACE_DATA table. All binary data may be stored and displayed on user interface screens as hex strings.

In a representative embodiment of the present invention, each log entry may comprise a device-dependent time value (u64 Time) to record when the log message is logged. This time value may be returned by an API on the electronic device and the unit, precision, time zone and basis of the time may differ from electronic device to electronic device. A diagnostic/trace server such as the diagnostic server 129 of FIG. 1 may be responsible for using the appropriate device-specific adaptor to convert this time value to a datetime value. In addition, the diagnostic/trace server may use the “i16UTCOffset” field in the log transmission header to calculate the device local time for the log entry (see above for details on how to use the “i16UTCOffsef” field). The device local time for the log entry may be stored in the DEVICE_DATE column in the SC_EVENT_TRACE_DATA table. Since datetime values in some software (e.g., the Oracle Datetime datatype) is only precise to seconds, addition precision (e.g., up to nanoseconds) may be stored in the DATE_FRACTION column.

In a representative embodiment of the present invention, the diagnostic/trace server may be responsible for capturing the datetime of when the log entry is received by the diagnostic/trace server. This datetime value may be stored as UTC in the last_response_date column in the MDI_LOG_EVENT table. If multiple transfer sessions for the same event (except for event id 0) are received by the diagnostic/trace server, the completion time of the last transfer session may be stored in the last_response_date column.

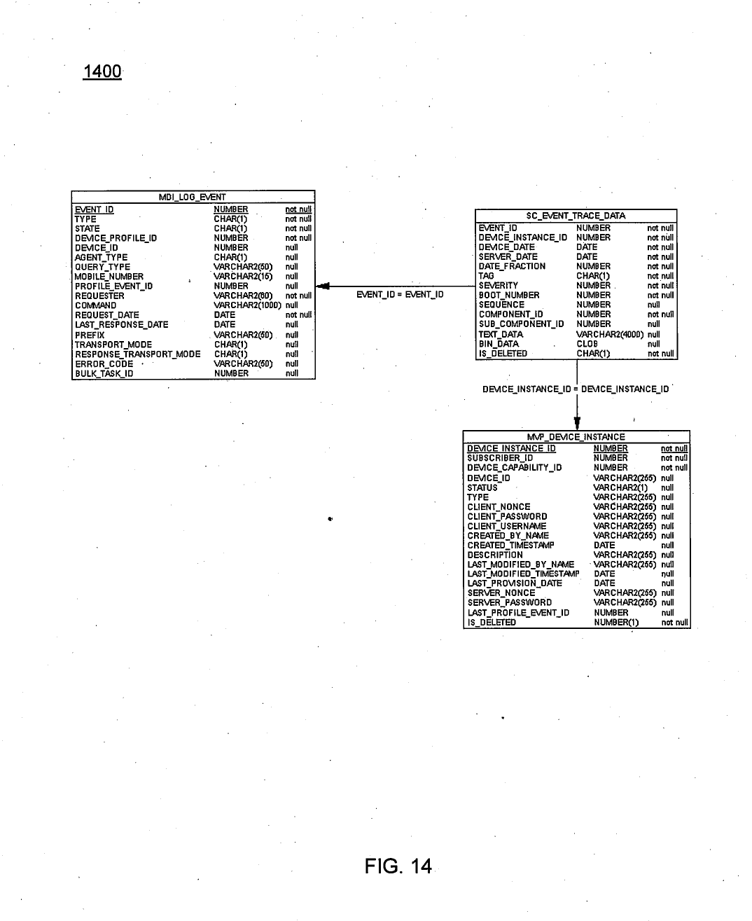

FIG. 14 shows an illustration of an exemplary SC_TRACE_DATA table and its relationship to other system tables, in accordance with a representative embodiment of the present invention.

In a representative embodiment of the present invention, if the message transmission header contains a valid Device ID and no such Device instance exists in the database, the diagnostic/trace server may be responsible for creating the Device instance record in the database. If the message transmission header contains a valid MSISDN and no such Subscriber instance exists in the database, the diagnostic/trace server may be responsible for creating the Subscriber instance record in the database. The Subscriber may be created under the DEFAULT Subscriber Class. If the message transmission header contains both a valid Device ID and a valid MSISDN, the diagnostic/trace server may be responsible for updating the Last Known Device on the Subscriber record and the Subscriber ID on the Device record.

A representative embodiment of the present invention may support a user interface screen for displaying diagnostic/trace data on a device-by-device basis. The user can provide one or more of the following search criteria to further streamline the results:
Device Local Datetime of Log Record (user can specify the FROM and TO datetime to form a range; precision may be in seconds)
Datetime when Log Record is received on the server, displayed according to the User's time zone (a User may specify the FROM and TO datetime to form a range; precision may be in seconds)
Boot Number
Severity Level
Component ID
Subcomponent ID

In some representative embodiments of the present invention, the list of available Components and Subcomponents may be preloaded into the database. In other representative embodiments of the present invention, there may be screens for searching, maintaining, and importing Components and Subcomponents.

Below are a few examples of how these search criteria may be combined to produce useful reports:
1. All FAULT messages generated by a specific Component
2. All messages, regardless of severity, generated by a particular component/subcomponent combination
3. All messages logged between Jan. 1, 2006 and Jan. 10, 2006, inclusive

In a representative embodiment of the present invention, search results may be displayed in tabular format. If there is any binary data, the “Binary?” column may show “Y”. By clicking on a magnifying class icon, a user may bring up a Trace Data Detail screen where binary data will be displayed as hex strings.

To delete a log entry, a user may check a checkbox of the log entry and click a “Delete” button. To delete multiple records, a user may check more than one checkbox and click the “Delete” button. To delete all records on the screen, a user may check a checkbox on the header to select all records, and then click the Delete button. Clicking on the header columns may allow a user to sort the results; Clicking on an “Export” button may export the search results to a CSV file. The format of such a CSV may, for example, be:
[Device Datetime] [Received Datetime] [tag] [Boot Number][Sequence Number][Severity][Component][Subcomponent][Text data][Binary data as hex]

In a representative embodiment of the present invention, if the data value is empty, it may be represented as an empty string. If the data value contains a comma, the entire field may be enclosed in double-quotes. If the data value contains a double-quote, the double quote may be escaped by another double-quote in front, and the entire data value may be enclosed in double quotes. For example, a data record with no binary data and text data containing double quotes and comma that may as follows:
2006/01/23 11:23:33 2006/01/23 11:26:12 1 12 22 DEBUG RADI SGNL Signal “extremely low”, problem
   may be converted to the following in CSV format:
2006/01/23 11:23:33,2006/01/23 11:26:12,1,12,22,DEBUG,RADI,SGNL, “Signal ““extremely low””, problem”,

In some representative embodiments of the present invention, there be no export or display of data in XML format.

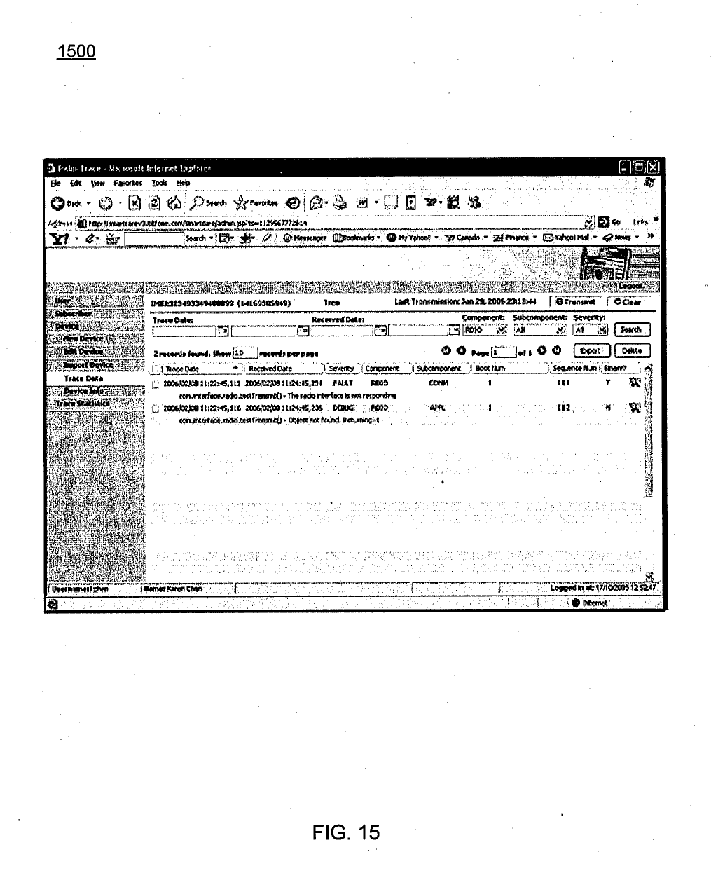

FIG. 15 illustrates an exemplary web page user interface screen 1500 for displaying diagnostic/trace data from, for example, an electronic device such as the electronic device 107 of FIG. 1, in accordance with a representative embodiment of the present invention.

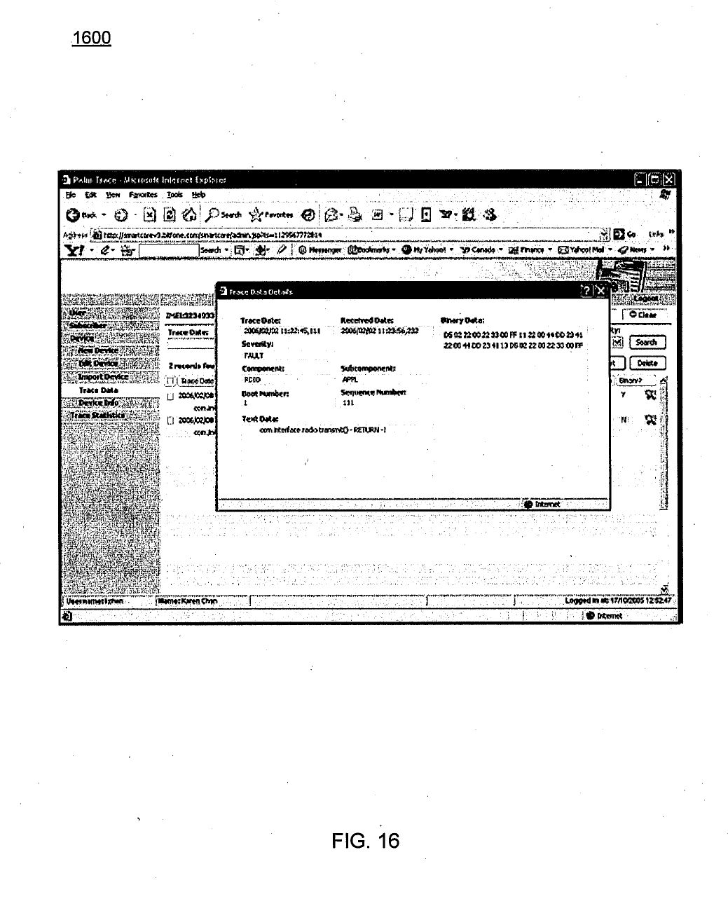

FIG. 16 illustrates an exemplary web page user interface screen 1600 for displaying detailed information from trace data that may correspond to the diagnostic/trace data of FIG. 15, in accordance with a representative embodiment of the present invention.

In a representative embodiment of the present invention, clicking the ‘Transmit’ button on the web page user interface screen 1500 for displaying diagnostic/trace data may send a specially formatted SMS message to the identified electronic device, to request a Trace Data Transfer. Such a request may employ either proprietary or standards-based protocol, such as that employed in the SmartCare and FusionDM products of Bitfone Corporation. When an electronic device such as the electronic device 107 of FIG. 1 receives a Trace Data Transfer Request, it may transmit trace entries on the electronic device for transmission. If logging is occurring in parallel with the request (i.e., at the same time as the request is processed), those log entries may be included in the transfer.

In a representative embodiment of the present invention, clicking the ‘Clear’ button on the web page user interface screen 1500 for displaying diagnostic/trace data may send a specially formatted SMS message to the identified device to clear all Trace Data. The Clear Data Request may employ either proprietary or standards-based protocol, such as that employed in the SmartCare and FusionDM products of Bitfone Corporation. When the electronic device receives a Clear Data Transfer Request, it may clear all trace entries on the electronic device.

In a representative embodiment of the present invention, the Super User may have the ability to retrieve trace data on one or more Devices. This feature allows the Super User to generate diagnostics statistics for a selected group of devices. The search criteria may include, for example:
One or more Device ID(s), comma separated—Wildcard character search may also be accepted. Leaving this field empty may generate a report that spans ALL devices in the system,
Device Local Datetime of Log Record (a User may specify the FROM and TO datetime to form a range; precision may be in seconds),
Datetime when Log Record is received on the diagnostic/trace server, displayed according to the User's time zone (user can specify the FROM and TO datetime to form a range; precision will be in seconds),
Severity Level
Boot Number
Sequence Number
Component ID
Subcomponent ID

Below are a few examples of how these search criteria may be combined to produce useful statistical reports:
1. All Call Drop events on a particular model of Device (based on a wildcard search using the TAC on the IMEI)
2. All FAULT messages generated by the RADIO component across all devices
3. All FAULT messages logged since a firmware update on Jan. 14, 2006 on a particular device

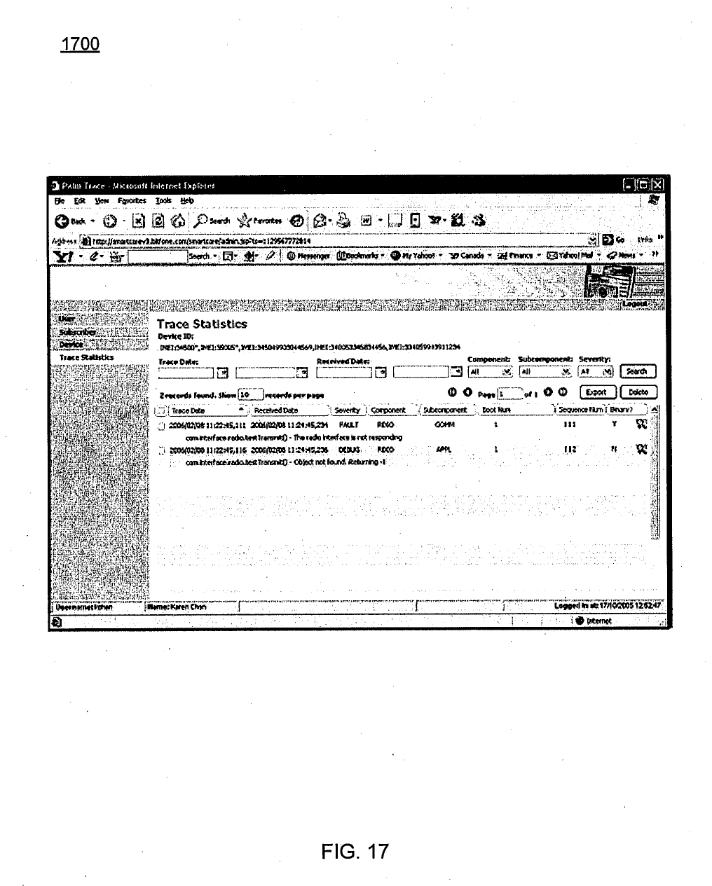

FIG. 17 illustrates an exemplary web page user interface screen 1700 for displaying trace statistics from trace data that may correspond to the diagnostic/trace data of FIG. 15, in accordance with a representative embodiment of the present invention.

In a representative embodiment of the present invention, there may be a user interface screen for displaying the most recent Device information collected. This Device information may includes the Device IMEI/ESN, Manufacturer, Model, Platform, Revision, Processor, OS Version, Free Memory, Signal Strength, and Data Connection Settings, for example. Additional Device data may be collected depending upon the functionality of the APIs in the electronic devices.

In a representative embodiment of the present invention, the most recently collected diagnostic/trace settings from the Device may also be displayed. These settings may include, for example:

1. A Collection of Filter Criteria

One or more Component IDs, Subcomponent IDs, Severity, Trigger combinations.
   2. Transfer Settings
Buffer Fullness Threshold, URL of a diagnostic/trace server, Real-time Mode (On/Off), Output Link to Server (On/Off), Output Link to PC (On/Off), Output Link to USB (On/Off), Periodic Trigger (On/Off), Interval between Transfer, and Schedule Time for Transfer.
   3. Other Settings
Internal Flash Buffer Size, and Internal RAM Buffer size.

In a representative embodiment of the present invention, data may be displayed as key-value pairs on the user interface screen and parameters may be categorized onto different tabs on the display.

To trigger a real-time collection of device data and diagnostic/trace settings in a representative embodiment of the present invention, a User may click on the “Profile” button.

To configure settings on the Device in a representative embodiment of the present invention, a User may click on a small “edit” icon next to an attribute. This may open up the field(s) for editing. After the settings are modified and saved, the User may click on “Configure” to see a Summary of configuration changes. The User may click on “Configure Device” to send the configuration changes to the Device.

In a representative embodiment of the present invention, the User may be configure and fix TCP/IP connectivity by editing settings on the “Connection” tab.

A representative embodiment of the present invention may make use of standards-based protocols, or a proprietary protocol such as that employed by the SmartCare and/or FusionDM products by Bitfone Corporation, for collection and modification of Device data and diagnostic/trace settings. A transport mode parameter for profile and configuration may be set to “Auto”, so that the Device may automatically try TCP/IP first, and then revert to SMS if TCP/IP connectivity is not available.

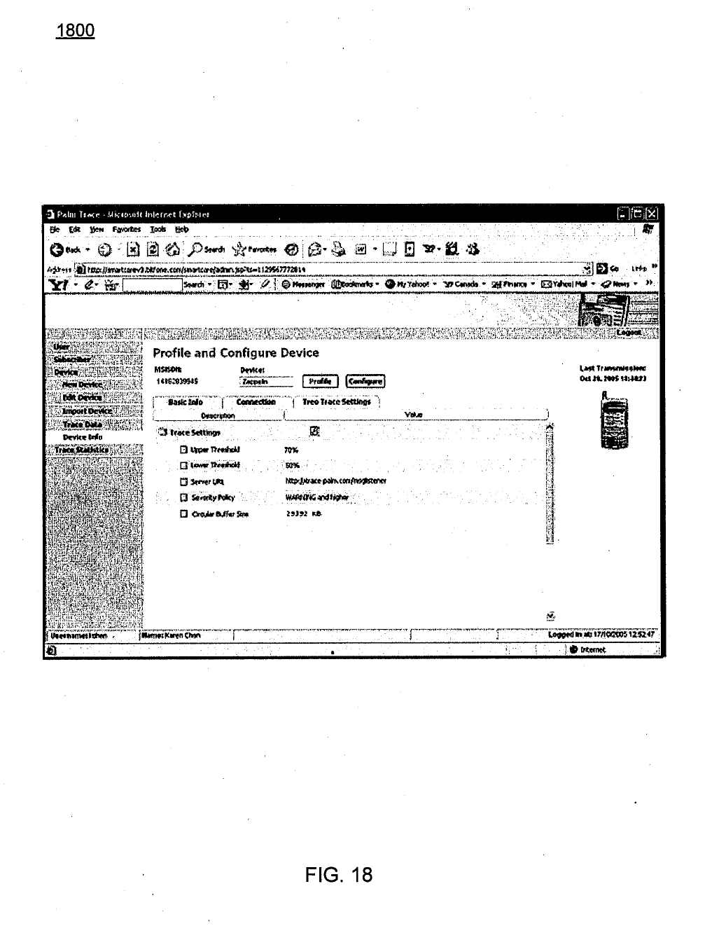

FIG. 18 illustrates an exemplary web page user interface screen 1800 for displaying device information that may correspond to an electronic device such as the electronic device 107 of FIG. 1, in accordance with a representative embodiment of the present invention.

Aspects of the present invention may be seen in a handheld electronic device comprising at least one non-volatile memory having stored therein one or both of firmware and software, and at least one processor operably coupled to the non-volatile memory. The at least one processor, during operation, may wirelessly receive, from a remote server via a communication network, configuration information for controlling one or more of diagnostic, monitoring and tracing activities in the handheld electronic device. The configuration information may be communicated according to a device management protocol standard. The at least one processor, during operation, may store the configuration information as a sub-node of a standards-defined device management object in a device management tree in the non-volatile memory, and may log information comprising one or both of events and operating parameters of the handheld electronic device based upon the configuration information for controlling one or more of diagnostic, monitoring and tracing activities in the handheld electronic device. The at least one processor, during operation, may also transfer the logged information to a remote server via a communication medium.

In a representative embodiment of the present invention, the handheld electronic device may comprise one of a mobile handset and a cellular phone, and may comprise one of a personal digital assistant and a personal computer. The received configuration information may be expressed as extensible markup language (XML), and the configuration information may be stored as a sub-node or part of a device management object defined in the Open Mobile Alliance (OMA) Device Management (DM) Version 1.2 or later protocol specification. Storing the configuration information may comprise adding an application-related sub-node to a standards-defined device management object in the device management tree.

In a representative embodiment of the present invention, the non-volatile memory may comprise flash type memory. The communication medium may comprise the communication network, a universal serial bus (USB) communication connection, and a non-volatile memory card known as a Secure Digital (SD) card. The communication network may comprise a public communication network. The configuration information may be accessible using an Open Mobile Alliance (OMA) UAProf based device profile. The logged information may be accessible as a sub-node of a standards-defined device management object in a device management tree, and the management object set or modified by storing configuration information may be initially set by a manufacturer of the handheld electronic device.

Further aspects of the present invention may be found in a computer-readable storage comprising a plurality of code sections for operating a handheld electronic device in a device management network. The plurality of code sections may have stored therein instruction code executable by a processor for causing the processor to perform a method. Such a method may comprise wirelessly receiving, via the device management network, configuration information for controlling one or more of diagnostic, monitoring and tracing activities in the handheld electronic device. The configuration information may be encoded to be compatible with a device management protocol standard. Such a method may comprise storing the configuration information in a non-standard sub-node of a standards-defined device management object of a device management tree in non-volatile memory of the handheld electronic device. Such a method may also comprise logging information comprising one or both of events and operating parameters of the handheld electronic device based upon the configuration information for controlling one or more of diagnostic, monitoring and tracing activities in the handheld electronic device. In addition, a method in accordance with the present invention may comprise transferring the logged information to a remote server via a communication medium.

In a representative embodiment of the present invention, the code sections may further comprise instruction code executable by the processor for causing the processor to wirelessly receive information for updating instruction code in the computer-readable storage to update functionality of the handheld electronic device. The handheld electronic device may comprise one of a mobile handset and a cellular phone, and the handheld electronic device may comprise one of a personal digital assistant and a personal computer. The received configuration information may be communicated as extensible markup language (XML), and the device management protocol standard may be the device management protocol referred to as the Open Mobile Alliance (OMA) Device Management (DM) Version 1.2 or later protocol. The non-volatile memory may comprise flash type memory.

In a representative embodiment of the present invention, storing the configuration information may comprise adding an application-related sub-node to a standards-defined device management object in the device management tree. The code sections may further comprise instruction code executable by the processor for causing the processor to wirelessly download update information used to update the one or both of firmware and software. The communication medium may comprise the communication network, a universal serial bus (USB) communication connection, and a non-volatile memory card known as a Secure Digital (SD) card. The device management network may comprise a public communication network. The configuration information may be accessible using an Open Mobile Alliance (OMA) UAProf based device profile. Storing the configuration information may comprise adding one or both of a diagnostic and a tracing-related non-standard sub-node from a standards-defined device management object in the device management tree. The logged information may be accessible as a sub-node of a standards-defined device management object in a device management tree.

Yet other aspects of the present invention may be seen in a system for managing diagnosis and tracing of a plurality of handheld electronic devices. Such a system may comprise at least one server comprising at least one interface enabling communication with the plurality of handheld electronic devices via a wireless communication network. The at least one processor may be operably coupled to the at least one interface and at least one memory containing configuration information for controlling one or more of diagnostic, monitoring and tracing activities in the plurality of handheld electronic devices and information for updating executable code in the plurality of handheld electronic devices. The at least one processor may function during operation to, among other things, receive a request for one or both of diagnostic and tracing functionality for one of the plurality of handheld electronic devices. The at least one processor may also function during operation to store configuration information for controlling one or more of diagnostic, monitoring and tracing activities for the one of the plurality of handheld electronic devices in the at least one memory. In addition, the at least one processor may transmit, to the one of the plurality of handheld electronic devices via the wireless communication network in accordance with a device management protocol standard, the configuration information for controlling one or more of diagnostic, monitoring and tracing activities for the one of the plurality of handheld electronic devices. The transmitted configuration information may be arranged to cause updating of a non-standard sub-node of a standards-defined device management object in a device management tree in memory of the one of the plurality of handheld electronic devices.

In a representative embodiment of the present invention, the plurality of handheld electronic devices may comprise one of a mobile handset and a cellular phone, and may comprise one of a personal digital assistant and a personal computer. Transmitted configuration information may be communicated as extensible markup language (XML), and the device management protocol standard may be the device management protocol referred to as the Open Mobile Alliance (OMA) Device Management (DM) Version 1.2 or later protocol. The at least one processor may function during operation to, among other things, receive logged information for one or more of diagnostic, monitoring and tracing activities from the device management tree of the one of the plurality of handheld electronic devices. The at least one processor may function during operation to, among other things, download update information used to update one or both of firmware and software to the one of the plurality of handheld electronic devices.

In a representative embodiment of the present invention, the communication network may comprise a public communication network. The device capability information may be arranged according to an Open Mobile Alliance (OMA) UAProf based device profile. The transmitted configuration information may be arranged to cause adding of a non-standard sub-node of a standards-defined device management object in the device management tree in memory of the one of the plurality of handheld electronic devices.

Still other aspects of the present invention may be found in a handheld electronic device comprising at least one memory having stored therein one or both of firmware and software. Changes in functionality of the handheld electronic device may be enabled by remotely updating the one or both of firmware and software. One or more of diagnostic, monitoring and tracing activities in the handheld device may be enabled by remotely provisioning configuration information for controlling one or more of diagnostic, monitoring and tracing activities as additional management objects in a standards-defined device management tree. The handheld electronic device comprises a cellular phone. The device management tree may be in accordance with a device management protocol referred to as the Open Mobile Alliance (OMA) Device Management (DM) Version 1.2 or later protocol.

Other aspects of the present invention may be observed in a system for managing one or more of diagnostic, monitoring and tracing activities in mobile electronic devices. Such a system may comprise at least one server communicatively coupled to at least one mobile electronic device. Configuration information resident in memory in the at least one mobile electronic device may act to control the one or more of diagnostic, monitoring and tracing activities of the at least one mobile electronic device, and the configuration information may be initially provisioned and subsequently managed using management objects based on a device management protocol referred to as the Open Mobile Alliance (OMA) Device Management (DM) Version 1.2 or later protocol standard. The at least one mobile electronic device may comprise a cellular phone. The initial provisioning of configuration information in the at least one mobile electronic device may be performed by a manufacturer of the at least one mobile electronic device. One or more of diagnostic, monitoring and tracing activities of the at least one mobile device may be enhanced by remotely updating, from the at least one server, one or both or firmware and software in the memory of the at least one mobile electronic device. The enhanced functionality of the at least one mobile electronic device may be enabled by new management objects provisioned, by the at least one server, into a device management tree in the memory.

Although a system and method according to the present invention has been described in connection with the preferred embodiment, it is not intended to be limited to the specific form set forth herein, but on the contrary, it is intended to cover such alternative, modifications, and equivalents, as can be reasonably included within the spirit and scope of the invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A handheld electronic device comprising:
at least one non-volatile memory having stored therein one or both of firmware and software;
at least one processor operably coupled to the non-volatile memory, wherein the at least one processor, during operation, at least:
wirelessly receives, from a remote server via a communication network, configuration information for controlling one or more of diagnostic, monitoring and tracing activities in the handheld electronic device, the configuration information communicated according to a device management protocol standard;
stores the configuration information as a sub-node of a standards-defined device management object in a device management tree in the non-volatile memory;
logs information comprising one or both of events and operating parameters of the handheld electronic device based upon the configuration information for controlling one or more of diagnostic, monitoring and tracing activities in the handheld electronic device; and
transfers the logged information to a remote server via a communication medium.

2. The handheld electronic device according to claim 1, wherein the handheld electronic device comprises one of a mobile handset and a cellular phone.

3. The handheld electronic device according to claim 1, wherein the handheld electronic device comprises one of a personal digital assistant and a personal computer.

4. The handheld electronic device according to claim 1, wherein the received configuration information is expressed as extensible markup language (XML).

5. The handheld electronic device according to claim 1, wherein the configuration information is stored as a sub-node or part of a device management object defined in the Open Mobile Alliance (OMA) Device Management (DM) Version 1.2 or later protocol specification.

6. The handheld electronic device according to claim 1, wherein storing the configuration information comprises adding an application-related sub-node to a standards-defined device management object in the device management tree.

7. The handheld electronic device according to claim 1, wherein the non-volatile memory comprises flash type memory.

8. The handheld electronic device according to claim 1, wherein the communication medium comprises the communication network.

9. The handheld electronic device according to claim 1, wherein the communication medium comprises a universal serial bus (USB) communication connection.

10. The handheld electronic device according to claim 1, wherein the communication medium comprises a non-volatile memory card known as a Secure Digital (SD) card.

11. The handheld electronic device according to claim 1, wherein the communication network comprises a public communication network.

12. The handheld electronic device according to claim 1, wherein the configuration information is accessible using an Open Mobile Alliance (OMA) UAProf based device profile.

13. The handheld electronic device according to claim 1, wherein the logged information is accessible as a sub-node of a standards-defined device management object in a device management tree.

14. The handheld electronic device according to claim 1, wherein the management object set or modified by storing configuration information is initially set by a manufacturer of the handheld electronic device.

15. A computer-readable storage comprising a plurality of code sections for operating a handheld electronic device in a device management network, the plurality of code sections having stored therein instruction code executable by a processor for causing the processor to perform a method comprising:
wirelessly receiving, via the device management network, configuration information for controlling one or more of diagnostic, monitoring and tracing activities in the handheld electronic device, the configuration information encoded to be compatible with a device management protocol standard;
storing the configuration information in a non-standard sub-node of a standards-defined device management object of a device management tree in non-volatile memory of the handheld electronic device;
logging information comprising one or both of events and operating parameters of the handheld electronic device based upon the configuration information for controlling one or more of diagnostic, monitoring and tracing activities in the handheld electronic device; and
transferring the logged information to a remote server via a communication medium.

16. The computer-readable storage according to claim 15, wherein the code sections further comprise instruction code executable by the processor for causing the processor to:
wirelessly receive information for updating instruction code in the computer-readable storage to update functionality of the handheld electronic device.

17. The computer-readable storage according to claim 15, wherein the handheld electronic device comprises one of a mobile handset and a cellular phone.

18. The computer-readable storage according to claim 15, wherein the handheld electronic device comprises one of a personal digital assistant and a personal computer.

19. The computer-readable storage according to claim 15, wherein the received configuration information is communicated as extensible markup language (XML).

20. The computer-readable storage according to claim 15, wherein the device management protocol standard is the device management protocol referred to as the Open Mobile Alliance (OMA) Device Management (DM) Version 1.2 or later protocol.

21. The computer-readable storage according to claim 15, wherein the non-volatile memory comprises flash type memory.

22. The computer-readable storage according to claim 15, wherein storing the configuration information comprises adding an application-related sub-node to a standards-defined device management object in the device management tree.

23. The computer-readable storage according to claim 15, wherein the code sections further comprise instruction code executable by the processor for causing the processor to:
wirelessly download update information used to update the one or both of firmware and software.

24. The computer-readable storage according to claim 15, wherein the communication medium comprises the communication network.

25. The computer-readable storage according to claim 15, wherein the communication medium comprises a universal serial bus (USB) communication connection.

26. The computer-readable storage according to claim 15, wherein the communication medium comprises a non-volatile memory card known as a Secure Digital (SD) card.

27. The computer-readable storage according to claim 15, wherein the device management network comprises a public communication network.

28. The computer-readable storage according to claim 15, wherein the configuration information is accessible using an Open Mobile Alliance (PMA) UAProf based device profile.

29. The computer-readable storage according to claim 15, wherein storing the configuration information comprises adding one or both of a diagnostic and a tracing-related non-standard sub-node from a standards-defined device management object in the device management tree.

30. The computer-readable storage according to claim 15, wherein the logged information is accessible as a sub-node of a standards-defined device management object in a device management tree.

31. A system for managing diagnosis and tracing of a plurality of handheld electronic devices, the system comprising:
at least one server comprising:
at least one interface enabling communication with the plurality of handheld electronic devices via a wireless communication network;
at least one processor operably coupled to the at least one interface and at least one memory containing configuration information for controlling one or more of diagnostic, monitoring and tracing activities in the plurality of handheld electronic devices and information for updating executable code in the plurality of handheld electronic devices, the at least one processor functioning during operation to, among other things:
receive a request for one or both of diagnostic and tracing functionality for one of the plurality of handheld electronic devices;
store configuration information for controlling one or more of diagnostic, monitoring and tracing activities for the one of the plurality of handheld electronic devices in the at least one memory; and
transmit, to the one of the plurality of handheld electronic devices via the wireless communication network in accordance with a device management protocol standard, the configuration information for controlling one or more of diagnostic, monitoring and tracing activities for the one of the plurality of handheld electronic devices, wherein the transmitted configuration information is arranged to cause updating of a non-standard sub-node of a standards-defined device management object in a device management tree in memory of the one of the plurality of handheld electronic devices.

32. The system according to claim 31, wherein the plurality of handheld electronic devices comprises one of a mobile handset and a cellular phone.

33. The system according to claim 31, wherein the plurality of handheld electronic devices comprises one of a personal digital assistant and a personal computer.

34. The system according to claim 31, wherein transmitted configuration information is communicated as extensible markup language (XML).

35. The system according to claim 31, wherein the device management protocol standard is the device management protocol referred to as the Open Mobile Alliance (OMA) Device Management (DM) Version 1.2 or later protocol.

36. The system according to claim 31, wherein the at least one processor functions during operation to, among other things:
receive logged information for one or more of diagnostic, monitoring and tracing activities from the device management tree of the one of the plurality of handheld electronic devices.

37. The system according to claim 31, wherein the at least one processor functions during operation to, among other things:
download update information used to update one or both of firmware and software to the one of the plurality of handheld electronic devices.

38. The system according to claim 31, wherein the communication network comprises a public communication network.

39. The system according to claim 31, wherein the device capability information is arranged according to an Open Mobile Alliance (OMA) UAProf based device profile.

40. The system according to claim 31, wherein the transmitted configuration information is arranged to cause adding of a non-standard sub-node of a standards-defined device management object in the device management tree in memory of the one of the plurality of handheld electronic devices.

41. A handheld electronic device comprising:
at least one memory having stored therein one or both of firmware and software;
wherein changes in functionality of the handheld electronic device are enabled by remotely updating the one or both of firmware and software; and
wherein one or more of diagnostic, monitoring and tracing activities in the handheld device is enabled by remotely provisioning configuration information for controlling one or more of diagnostic, monitoring and tracing activities as additional management objects in a standards-defined device management tree.

42. The handheld electronic device according to claim 41, wherein the handheld electronic device comprises a cellular phone.

43. The handheld electronic device according to claim 41, wherein the device management tree is in accordance with a device management protocol referred to as the Open Mobile Alliance (OMA) Device Management (DM) Version 1.2 or later protocol.

44. A system for managing one or more of diagnostic, monitoring and tracing activities in mobile electronic devices, the system comprising: at least one server communicatively coupled to at least one mobile electronic device, wherein configuration information resident in memory in the at least one mobile electronic device acts to control the one or more of diagnostic, monitoring and tracing activities of the at least one mobile electronic device, and wherein the configuration information is initially provisioned and subsequently managed using management objects based on a device management protocol referred to as the Open Mobile Alliance (OMA) Device Management (DM) Version 1.2 or later protocol standard.

45. The system according to claim 44, wherein the at least one mobile electronic device comprises a cellular phone.

46. The system according to claim 44, wherein the initial provisioning of configuration information in the at least one mobile electronic device is performed by a manufacturer of the at least one mobile electronic device.

47. The system according to claim 44, wherein one or more of diagnostic, monitoring and tracing activities of the at least one mobile device is enhanced by remotely updating, from the at least one server, one or both or firmware and software in the memory of the at least one mobile electronic device, and wherein the enhanced functionality of the at least one mobile electronic device is enabled by new management objects provisioned, by the at least one server, into a device management tree in the memory.
